(19) United States
(12) Patent Application Publication
(10) Pub. No.: US 2009/0319365 A1
(43) Pub. Date: Dec. 24, 2009

(54) System and method for assessing marketing data

(76) Inventors: James Hallowell Waggoner, Upper Montclair, NJ (US); Gary Getto, Landsdale, PA (US); Gert Hercules Louw, New York, NY (US)

Correspondence Address: Bakos & Kritzer, LLP, 27 Laurel Avenue, Summit, NJ, 07901, US

(21) Appl. No.: 12/383,443

(22) Filed: Mar. 23, 2009

Related U.S. Application Data
(63) Continuation-in-part of application No. 11/854,771, filed on Sep. 13, 2007.
(60) Provisional application No. 60/844,177, filed on Sep. 13, 2006.

(51) Int. Cl. G06Q 30/00; G06Q 50/00

(52) U.S. Cl. 705/14.41; 705/14.49; 705/14.69; 705/14.7; 705/26

(57) ABSTRACT

The present invention includes a system and method for managing media received from a plurality of media sources. Media content is received from a media source over a communication network. The media content is formatted in a first format and comprises news and advertising material relating to a respective subject. The received media content is processed into processed content, wherein the processing includes filtering, annotating and standardizing the content. Moreover, processed content is rendered, wherein the rendering includes transforming the processed content from the first format into a second format. The processed content formatted in the second format is stored in an electronic storage repository, and, in response to a search for the processed content, the processed content is retrieved from the electronic storage repository. Further, the processed content is further transformed from the second format to a third format, and delivered in the third format to a user.

### CROSS-REFERENCE TO RELATED APPLICATIONS

This continuation-in-part application is based on and claims the priority of co-pending application Ser. No. 11/854,771, filed Sep. 13, 2007, which claims the benefit of U.S. Provisional Patent Application No. 60/844,177, which was filed on Sep. 13, 2006 and entitled “System and Method for Assessing Marketing Data.”

### BACKGROUND OF THE INVENTION

1. Field of the Invention

The present invention relates to media monitoring services, and, more particularly, to an integrated computerized platform of reusable services associated with media content.

2. Description of the Related Art

Media tracking and analysis is a critical aspect of a company's or an individual's operation. By tracking the receptiveness of historical campaigns, an entity or individual can model successful future campaigns thereby effectively managing its resources. Efficient tracking of news coverage against business outcomes is a necessary tool for predicting the success rates of business efforts and campaigns.

In order to track media against business outcomes, industries have developed various metrics. Historically, three metrics have been developed including story counts, impressions, or media values. Story counts metric is a mere tally of each media placement. As a basic tally, there is no distinction between a story in a large daily newspaper versus a story in a small local newspaper. Likewise, there is no distinction between a mention in a TV program versus a mention in an internet story. Thus, while this is a very easy metric to calculate, it is not effective in establishing a precise metric for media impact.

Impressions metric, sometimes referred to as an “opportunity to see” the story, measures the audience that is reached. Each “hit” is weighted based on the audience size of the media source. For example, a high-reach daily newspaper would have significantly more weight than a local weekly paper. Generally, the impressions metric provides a more precise measure of communications impact than story counts as it incorporates a weighting function. However, the impressions metric does not differentiate between a full-page feature article and a mere mention in an article since each media forum has the same reach and therefore the same weighting.

In contrast to the story count metric and impression metric, the media value metric incorporates several additional measures resulting in a more accurate analysis of impact. The media value metric is based primarily on the market value paid for advertising space in a particular media source. It will be readily understood by one of ordinary skill in the art that the fair market value is typically higher for higher reach media sources. The market value is also generally proportional to the amount of coverage in the particular media source. As a result, a large article will have more weight than a mere mention in the same media source. Thus, the media value metric clearly acts as a reasonable metric for evaluating a broad range of media impact since the metric takes into account high space/low reach insertions with low space/high reach insertions or any scale therebetween.

In contrast, Media Prominence Index (“MPI”) is a metric that has shown to be a far more reliable measure of communications effectiveness as compared to the aforementioned historic methods. Generally, the higher the MPI, the more likely that a particular form of communication (e.g., printed material, broadcast, or web-based media) has an impact.

MPI employs a metric known in the art as a media value, previously referred to as an ad value equivalency. As used herein, the term, “media value,” refers generally to a market driven value of a print, broadcast, or internet placement based on the cost or rate that a media source (e.g., the outlet in which coverage appears) would charge if that space could be purchased. Various factors, including the credibility of the source, the source's audience reach, and the length of the news coverage may impact the media value. Media values use the rate that a media source would charge for placing an advertisement and applies that determined rate to the space or time for the message. For example, a 3 column-inch (a standard measure of space, primarily for newspaper advertising, wherein one column-inch is one standard newspaper column wide [2 1/16″] by one standard column high [1″]) article in the New York Times would be valued as if a 3 column-inch advertisement was purchased. Broadcast sources generally state their rates not in column-inches, but as the cost per 30-second commercial. Media value is therefore a market-driven metric.

The use of media values as the basis for an MPI has a strong foundation. Research has demonstrated that measuring the effectiveness of a person's or organization's media outreach by calculating media values is 13% more likely to correlate to an outcome than using the known “impressions” standard, and 25% more likely than the known “story counts” standard. Thus, audience impressions are 12% more likely to correlate to an outcome than using story counts.

Typically, impressions differentiate between a relatively low-reach publication and a relatively high-reach publication, for example, the Des Moines Register versus the New York Times, respectively. However, a 2-second broadcast segment that generates the same number of impressions as a 2-minute broadcast segment indicates that the impressions metric does not sufficiently capture the full impact of all media placement. Media value not only differentiates between higher reach sources but also takes into account the degree of coverage. Media value further differentiates between sources with lower credibility, such as supermarket tabloids, versus highly credible sources like the New York Times.

Media value also differentiates between articles in which a person, organization, or agency is mentioned alone versus articles in which the person, organization, or agency shares coverage, for example, with a competitor. In case a person is mentioned alone, the media value factors full credit for the person/organization for the value of that coverage. Alternatively, if coverage is shared, only an appropriate fraction of that coverage is factored.

The MPI metric uses the media value and further modifies it by additional variables including “tone,” “prominence” or likelihood of impact, and exclusivity of coverage. As used herein, tone refers, generally, to the editorial “attitude” a news item conveys toward a company. In a preferred embodiment, tone is coded on a 9-point scale where 9 represents extremely positive, 8 represents very positive, 7 represents positive, 6 represents somewhat positive, 5 represents neutral/balanced, 4 represents somewhat negative, 3 represents negative, 2 represents very negative and 1 represents extremely negative. Thus, a negative article generates a negative value. A neutral article has less value than a positive article, while a very positive article has a higher value than just a modestly positive article.

Prominence or likelihood of impact, generally, represents a measure of the likelihood that the news coverage will have an impact. Likelihood of impact is highest where the company or message is in the headline or lead paragraph and is lowest when the mention is near the end of an article. The more likely that coverage is to be seen, the higher the likelihood of impact score. Understandably, if a person/organization is mentioned in a headline or lead paragraph, then that person/organization is more likely to be read and noticed by others. Therefore, the MPI increases by a percentage value to reflect such greater likelihood to generate impact. On the other hand, if the mention is buried at the very end of the article, it is far less likely to be noticed and therefore the MPI is reduced. Like tone, likelihood of impact is preferably measured on a 9-point scale.

Tone has more impact in the MPI metric than likelihood of impact. A very positive article where a person/organization is mentioned in the article's headline has almost double the impact of a neutral article where the person/organization is mentioned near the end of the article. The values used are developed through extensive regression analysis to determine the correct weightings.

For example, a 75 word article in the New York Times (3 column-inches) has a Media Value of $3,159.00, and represents the amount that the New York Times charges an advertiser for a 3 column inch advertisement. The article is evaluated for tonality, i.e., the degree of positive or negative attributes. For example, the article is considered to be positive and is rated as a “7” on a 9-point scale from extremely positive to extremely negative. Thereafter, prominence is determined by evaluating where the mention of the individual/organization appears in the article. If the mention appears in paragraph 3 of a 5 paragraph story, prominence may be rated as a “5” on a 9-point scale from headline to footnote.

Thereafter, the Media Prominence Index is calculated by multiplying the media value by a multiplier based on the tonality and a second multiplier based on the likelihood of impact. These multipliers are determined through regression analysis from several million articles and fine-tuned through a study of over 200,000 articles.

Example multipliers for tonality are listed in table 102 shown in FIG. 1A. Further, example multipliers for prominence or likelihood of impact are listed in table 104 in FIG. 1B. FIG. 1C depicts a table 106 showing various MPI's in accordance with the length in words, column inches, media value, tone, prominence and multipliers. The Media Prominence Index can be expressed as a dollar metric or without the dollar sign as a unit-less metric.

While the analysis of the absolute values of media impact is important, a more useful correlation in the art takes into the relative coverage of an entity's communications versus those of its competitors (i.e., is the entity's communications able to generate a competitive advantage). Thus, taking one company's MPI value and comparing the MPI value to the total MPI value of all competitors yields a metric known as Share of Discussion. Thus, one of ordinary skill in the art will readily recognize that Share of Discussion is usually much more highly correlated against business outcomes than the absolute value of MPI.

For many business categories, news coverage is the predominant communications driver and the procedure outlined for assigning the Media Prominence Index is effective for determining the positive, neutral, or negative impact of communications activities on business outcomes. However, in categories with high levels of paid advertising spending, the impact of news activity becomes difficult or impossible to measure without also looking at the impact of the paid advertising.

Similar to the measurement of communications impact for news, there are several commonly used metrics for paid advertising. In short, advertising spending is a metric representing a measure of advertising impact. Typically, advertising metrics are expressed in absolute terms and are based on a projected audience reach of the advertisement or the dollar value of the advertisement. An advertisement or advertisement campaign with higher advertising spending will have more impact than one with lower advertising spending.

Audience impact, perhaps the most popular measurement of advertising impact, is usually expressed in absolute numbers or as Gross Rating Points (“GRP”) and spending (i.e., a measure of how much money was spent on the specific paid advertising or collective advertising campaign in one or more forums). As an example, one might describe an advertising campaign as having reached an audience of one million people in a specific target audience. This assertion correlates to 10 GRPs provided that the target audience is 10,000,000 people (1% of the audience would be 100,000 people so 1,000,000 would be 10 GRPs.) As commonly applied, a GRP of 10 can mean that the advertisement reached 1% of the audience 10 times or 10% of the audience once or any point in between.

Since the audience impact modeling outlined above involves a degree of complexity and interpretation, most paid advertising analysis is based on a more simplistic level of “reach” and/or “frequency” versus “results.” Specifically, “reach” is defined as the number of audience members “touched” with the marketing message or the number of audience members that are exposed to the marketing message. “Frequency” is commonly defined as the number of times an audience member is “touched” with the marketing message. Finally, these impressions are correlated with the ultimate “results,” which, in the case of a consumer product for example, is often measured as a function of increased product sales for a specific time period.

Improved correlation of this methodology for measuring advertising impact can be achieved by factoring in the impact of the particular advertising an agency utilized, basing the correlation on share of communications versus just an absolute level of communications, and the choice of media types.

It is readily apparent that the advertising measurements commonly employed are ineffective as they merely simplify and generalize the true effectiveness or impact of advertising campaigns. Specifically, current paid advertising analysis treats advertising creative as if all advertisements are the same or substantially similar. If two advertising campaigns reach the same audience, spend the same amount of money, etc. the two advertising campaigns are deemed to have equivalent impact on business outcomes. However, in reality, this premise of equivalent impact is far from accurate as there is a significant difference in the effectiveness of paid advertising across a broad range of medium. For example, when comparing a first advertising campaign to a second advertising campaign with the “equivalent impact on business outcomes,” the first advertising campaign may enable a viewer to recall the name of the advertiser, enable a viewer to find the advertisement likeable, deliver a clear and memorable message to a viewer, generate a call to action, or improve the reputation of the advertiser while the second advertising campaign may not accomplish any of these desired objectives. Thus, the first advertising campaign may effectively “enhance” a viewer's willingness to do business with this advertised entity of the campaign while the second advertising campaign has no or limited impression on the desired viewer or audience.

Further, improved correlation of this methodology for measuring advertising impact can be achieved by factoring the “share of voice.” As previously mentioned with respect to news analysis, the absolute level of paid advertising is less important than the relative level of coverage compared to the advertiser's competitors. For example, if an advertiser increases its advertisement budget by an absolute budget percentage of ten percent, but the advertiser's competitors increase their respective advertising budgets by an absolute percentage of twenty percent, the advertiser will likely see a decline in results as its relative coverage in the marketplace as decreased despite its increase in advertising expenditure.

A further useful correlation factor relates to the “media mix.” Advertisers can reach a desired target audience using any number of media resources or outlets. However, the impact of different media outlets yields varied results. Thus, spending is a more accurate criterion than mere analysis of audience reach. This is readily apparent in the industry as the marketplace tends to charge more for higher impact and less for lower impact segments.

Although the use of MPI and the aforementioned parameters related to advertising spending, historically, have been useful, the incremental developments and improvements over a period of time have led to piece-meal, non-integrated solutions. Specifically, these solutions by their nature do not provide an integrated view of the news and advertising data, are difficult to modify, difficult to enhance due to the third parties involved, and backward compatibility of new versions are becoming increasingly difficult due to the custom nature of each client installation.

### SUMMARY OF THE INVENTION

The present invention includes a system and method for managing and correlating media received from a plurality of media sources and advertising presented in various media forums. Preferably, media content is received from a media source over a communication network; however, it is contemplated by the present invention that data sources may be acquired over various transmission systems including the delivery of media content in paper form. When received, the media content is formatted in a first format and comprises news and advertising material relating to a respective subject. Thereafter, the received media content is processed into processed content, wherein the processing includes filtering the content, annotating and standardizing the content. Moreover, processed content is rendered, wherein the rendering includes transforming the processed content from the first format into a second format. The processed content formatted in the second format is stored in an electronic storage repository, and, in response to a search for the processed content, the processed content is retrieved from the electronic storage repository. The processed content is further transformed from the second format to a third format, and delivered in the third format to a user.

The present invention provides a series of novel correlation metrics that allow the system to process the media, whether in news format, advertising format, consumer-generated format, etc. and present a comparison of communications effectiveness. Specifically, the present invention calculates a Media Prominence Index. As described, supra, the Media Prominence Index is a metric for measuring communications effectiveness, i.e., prescribing a value to the impact a particular form of communication (e.g., printed material, broadcast, or web-based media) has on a viewer. In addition, the present invention calculates an Advertisement Prominence Index (“API”). In short, the API is a unique metric which combines advertising spending for a single campaign and occurrence data and further weighs the combination to determine the impact on a targeted viewer. Where necessary, the API further enables the summation of multiple campaigns across various media types (print, broadcast, web, etc.) to determine the overall impact or effectiveness of a total campaign. Importantly, the API can further represent a measurement of the effectiveness or impact of an advertising campaign against competitors' campaigns. Finally, the present invention provides a method for calculating a third unique metric for correlating the media prominence and the advertising prominence. This third metric, the Integrated Media Index, is designed to present an integrated measurement of the dynamic interrelationship between the “share of voice” and “share of discussion.”

Other features and advantages of the present invention will become apparent from the following description of the invention that refers to the accompanying drawings.

### BRIEF DESCRIPTION OF THE DRAWINGS

For the purpose of illustrating the invention, there is shown in the drawings a form which is presently preferred as well as certain alternate embodiments, it being understood, however, that the invention is not limited to the precise arrangements and instrumentalities shown as the illustrated embodiments are merely exemplary of systems and methods for carrying out the present invention, both the organization and method of operation of the invention, in general, together with further objectives and advantages thereof. The drawings are not intended to limit the scope of this invention, which is set forth with particularity in the claims as appended or as subsequently amended, but merely to clarify and exemplify the invention. The features and advantages of the present invention will become apparent from the following description of the invention that refers to the accompanying drawings, in which:

FIG. 1A is a table showing multiplier values associated with tonality descriptions;

FIG. 1B is a table showing multiplier values associated with media prominence descriptions for print and broadcast media;

FIG. 1C is a table showing various media prominence indices in accordance with the length in words, column inches, media value, tone, prominence and multipliers;

FIG. 1D is a table showing a series of advertisements for a particular product “X” offered and advertised by sample Company XYZ depicting the Advertisement Prominence Index calculation for the advertisements in various media forums;

FIG. 1E is a table showing the Ad Calculation Index for a particular advertising campaign of product “X” offered and advertised by sample Company XYZ based primarily on a consumer panel evaluation;

FIG. 1F is a table depicting the Dynamic Ad Calculation Index for a particular advertising campaign of product “X” offered and advertised by sample Company XYZ reflecting change in Ad Index based on news environment;

FIG. 1G is a table depicting the MPI index and correlating standard Ad Index Change Factor for calculating the Dynamic Ad Calculation Index for a particular advertising campaign;

FIG. 1H is a table depicting Dynamic Ad Effectiveness Index for a particular advertising campaign of product “X” offered and advertised by sample Company XYZ reflecting relative Ad Index Values relative to news environment during different time periods over various media forums;

FIG. 2 is a block diagram that illustrates an example enterprise architecture, including components and processes, provided in accordance with an embodiment of the present invention;

FIG. 3 is a UML class diagram illustrating relationships of users to sites, and sites to accounts;

FIG. 4 is a block diagram representing a conceptual graphical view of an architecture implemented in accordance with a preferred embodiment of the present invention;

FIG. 5 is a chart illustrating session security elements that are defined in accordance with a preferred embodiment of the present invention;

FIG. 6 illustrates steps associated with collection, pre-processing, and completion of ingestion;

FIG. 7 illustrates an example template management service display screen in accordance with a preferred embodiment of the present invention;

FIG. 8 illustrates an example hardware arrangement, in accordance with an embodiment of the present invention of the present invention;

FIG. 9 illustrates the functional elements of an example information processor;

FIG. 10 illustrates an example service display screen depicting the Integrated Media Intelligence in accordance with an embodiment of the present invention;

FIG. 11 illustrates an example messaging module display screen depicting the levels of communications for each message or topic including the interrelation therebetween (i.e., the “co-occurrence”) in accordance with an embodiment of the present invention;

FIG. 12 illustrates an example trend center display screen depicting the trends as a result of the Integrated Media Index, Media Prominence Index, and Advertising Prominence Index for a specific time series in accordance with an embodiment of the present invention;

FIG. 13 illustrates an example trend center display screen depicting the trends as a result of the Integrated Media Index, Media Prominence Index, and Advertising Prominence Index as a specific percentage of prominence in accordance with an embodiment of the present invention;

FIG. 14 illustrates an example trend center display screen depicting the trends as a result of Integrated Media Index, Media Prominence Index, and Advertising Prominence Index as a specific raw value in accordance with an embodiment of the present invention;

FIG. 15 illustrates an example key topics display screen depicting data points reflecting actual individual news or advertising segments for generating correlation prominence metrics allowing a user to access and analyze individual data points in accordance with an embodiment of the present invention;

FIG. 16 illustrates an example correlation module screen display for plotting various set of variables obtained in the trend module or various set of variables inputted from other sources in accordance with an embodiment of the present invention; and

FIG. 17 illustrates an example report module screen display allowing various reporting formats and delivery methods for same in accordance with an embodiment of the present invention.

### DETAILED DESCRIPTION OF THE EMBODIMENTS

A detailed illustrative embodiment as well as several alternate embodiments of the present invention are disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiments for purposes of disclosure and to provide a basis for the claims herein which define the scope of the present invention. Well known methods, procedures, and substances for both carrying out the objectives of the present invention and illustrating the preferred embodiment are incorporated herein but have not been described in detail as not to unnecessarily obscure novel aspects of the present invention.

The present invention provides a single unified environment shown in the drawings and referred to herein as Integrated Media Intelligence (“IMI”). The Integrated Media Intelligence environment, preferably including a product line of internet web site (“web-based”) offerings, provides integrated access to a suite of offerings associated with the Media Prominence Index, Advertising Prominence Index, and Integrated Media Index. Each index is described in greater detail herein. While the preferred embodiment of the present invention is directed to a series of internet web-site offerings, one of ordinary skill in the art will readily recognize that the system of the present invention may be employed on various alternate platforms and in alternate modes such as operating via the intranet, peer-to-peer, in proprietary software form, etc. In a preferred business method, a plurality of service offerings are provided that include varying degrees of functionality.

In one embodiment providing a relatively basic service, users contract with a proprietor of the present invention for various information deliverables. Content, which may be provided for a fixed fee, a variable fee or no fee, includes subscription-monitoring reports. Preferably, all media types are supported, including printed media, broadcast media and internet-related media. User-provided material may also be supported. Preferably, users are encouraged to engage in various activities and in return are provided rudimentary reporting and searching services. Various sophisticated features, such as charting or collaborative software elements like show rooms, (described in greater detail, below) are preferably not provided to users in this embodiment. Various services provided to users preferably include online ordering and incremental ad hoc purchases of various offerings, such as tapes, transcripts, Q.V. preview, audience numbers data, media values, MPI, or the like. The system further supports the automation of order processing and billing, thereby allowing users to review account activity. Further in this embodiment, sales and management metrics are provided in support of sales initiatives and general planning. Ordering is preferably supported in both incremental credit card purchases and account base purchasing. In addition, this embodiment provides access to and works in connection with one or more applications, including INSIGHT CONTACTS, NEWSROOM, ADSITE, REALTIME, and previous versions of APEX, offered by the assignee of the present patent application. It is readily understood that numerous publicly-available third party applications may be integrated with the present invention, as well as future applications developed by assignee, which allow for a shared platform and integration of such applications. For example, certain third-party applications now exist that collate various media sources and generate reporting of media data. It will be readily apparent to those of ordinary skill in the art that such applications easily integrate with the system of the present invention thereby creating a real-time analysis environment for evaluating the impact of such media data. These aforementioned applications provide, for example, support for campaign creation, execution and response monitoring, as well as integration with various modules and applications to build a list of media contacts to which new and existing press releases will be distributed. Customized media contact lists from a database are preferably used, for example, as the target for campaigns. Further, customers are provided with access to advertising media content and associated information such as impressions and advertising spending and occurrence data. Site visitors also preferably purchase advertising media clips, on-line and on-demand using credit cards or other electronic payment methods. Also, preferably included is the ability to quickly and easily view a company's summary of recent media references using easy-to-read graphical visualizations such as the green-yellow-red stoplight model provided in a dashboard view.

An alternative embodiment provides an intermediate level of services and includes features described above and further provides additional storage options, CD delivery of archived material, limited charting tools, user managed folders and collaborative tools like coverage centers and e-mail reporting tools. The package further allows users to add their own content and support data feeds from other third parties, separate from media monitoring parties that track and collect editorial coverage for businesses from a variety of media sources, such as BURRELLESLUCE.

Yet another embodiment provides all of the features of the intermediate level of services, and further incorporates data tagging and the associated additional reports and charts that are derived from the tagged data. This package preferably enables customers to filter, search and sort their respective media coverage from print, broadcast and internet based sources. Users are preferably able to create web enabled reports and charts quickly, to track breaking news, and otherwise to analyze their media coverage. These reports can then be saved or shared with others. Moreover, categorization and coding of the media coverage collected is performed in both an automated and manual manner and ties to the other modules allowing users to map their coverage to press releases or detailed information on the media source.

An additional embodiment provides for a customized incorporation of features and includes a facility for completing ongoing custom work for users. Of course, one skilled in the art will recognize that a number of other packages are envisioned and supported. These include data porting utilities, support for billing and other backend software, and ties to, and porting of, additional user application packages, such as CONTACTS, ADSITE, NEWSROOM, APEX and PRTRAK affiliate calculators.

Yet another embodiment provides for a combined view of editorial and advertising data, combining the MPI values and advertising spending values, and preferably comparing messaging and concepts that are delivered by advertising and editorial/PR programs. This preferably enables a complete view of the communications impact of all programs. A further embodiment provides the ability to compare the communications impacts with business results to help determine the impact and return on investment of communications investments as well as provide a resource tool for developing new campaigns.

Preferably, media content items acquired through the various media channels arrive with metadata, as known in the art. For example, a newspaper article typically includes metadata identifying the publisher and date. A television clip may arrive with the closed caption text attached as metadata. This metadata is often a key component of the media content as it is the basis for the management, reporting and analysis of media items. Preferably, additional metadata is associated with media content at various points, such as during the ingestion process, described below.

Importantly, the various embodiments of the present invention presented herein are designed to present a correlation of data in an easily readable and interpretable form. Specifically, the present invention is designed to correlate the aforementioned Media Prominence Index, the Advertising Prominence Index, and the Integrated Media Index as well as other known metrics common in the industry to provide a unified system and method for analyzing public relations and advertising impact.

While the Media Prominence Index has been a useful tool in measuring news impact, the present invention employs a new and unique system and method for measuring advertising impact. Advertising Prominence Index, or API, evaluates advertisement spending as a function of Ad Effectiveness Index. As presented herein, an individual advertisement is scored based on a number of factors. Such predetermined factors include, but are not limited to, likeability to a targeted viewer, brand recall after the advertisement is viewed, clear benefit conveyed by the advertisement, the complexity of the advertisement (i.e., was the advertisement easy to understand and comprehend), relevance of the advertisement, call to action as a result of the advertisement, and the reputational impact of the advertisement. Of course, one of ordinary skill in the art will readily recognize that not all factors may be analyzed for each advertisement and that additional factors based on the specifics of the advertisement may be utilized in accordance with the user-specific selection. These factors are each weighted and analyzed to generate a single combined index value based on the user-specified weighting. As a result, a general index can be prescribed and/or a user-defined specialty index can be generated based on the indices and weighting of different factors based on importance within a particular category. While an index can be calculated for a single category, typically, these determined indices are set to an absolute value and compared against indexed values of all advertisements in a campaign or against indexed values of competitor campaigns. Typically, an Ad Index of average is attributed a numerical value of 100 allowing for easy reference to other advertisements of other campaigns. Clearly, an advertisement or advertisement campaign with higher API values will have a greater impact on the targeted viewer than an effort with a lower API value. Generating a combined API for a company or brand and comparing it against the total API for all competitive companies or brands yields a weighted “Share of Voice” metric which yields significantly improved correlation against business outcome and prediction.

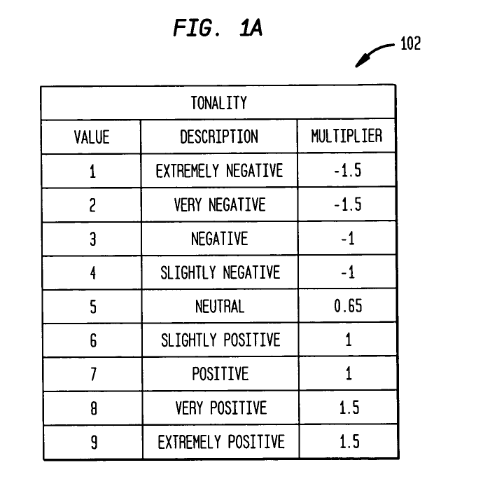

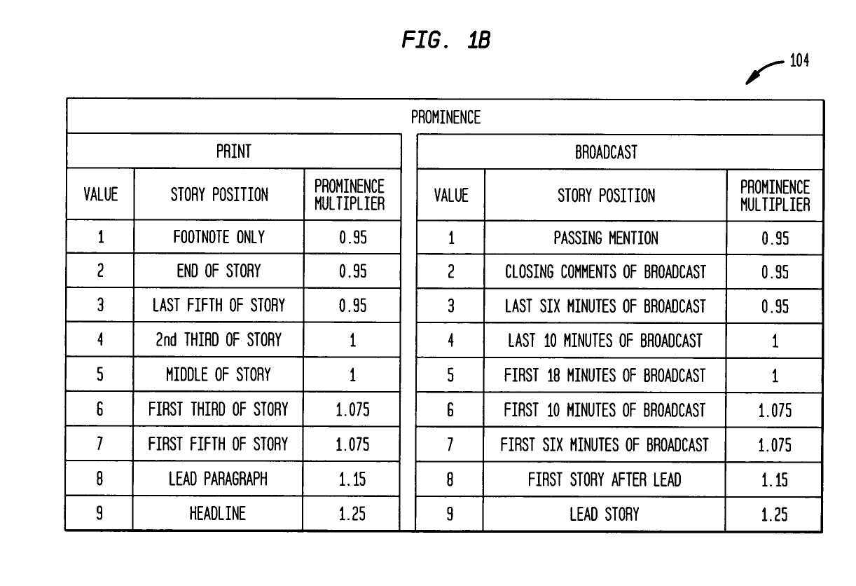

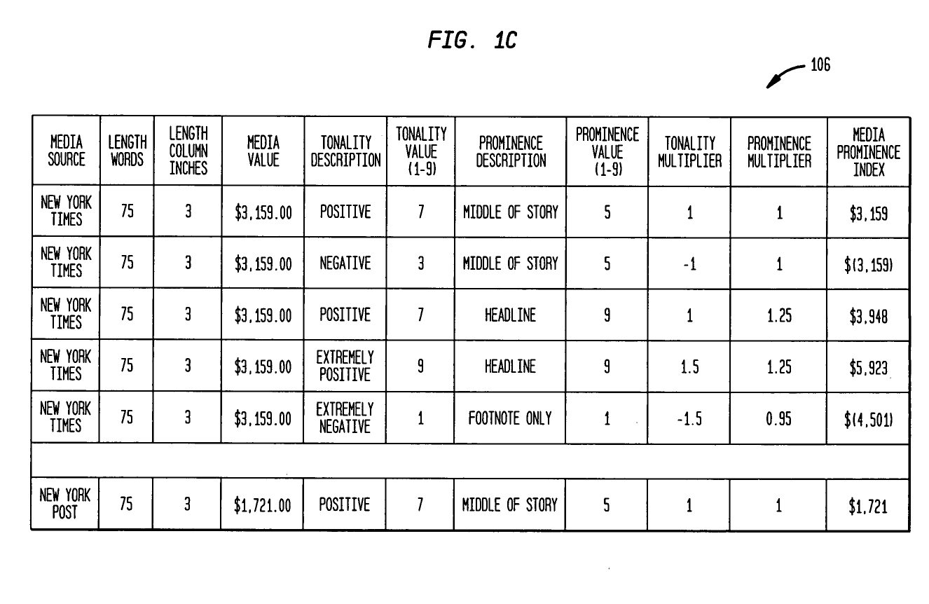

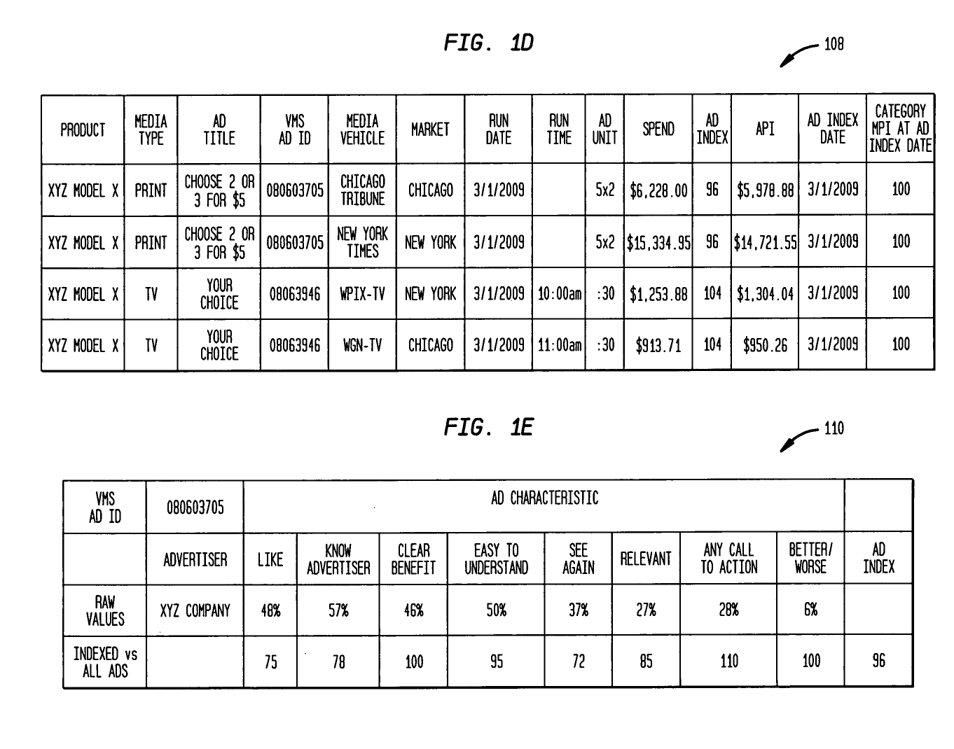

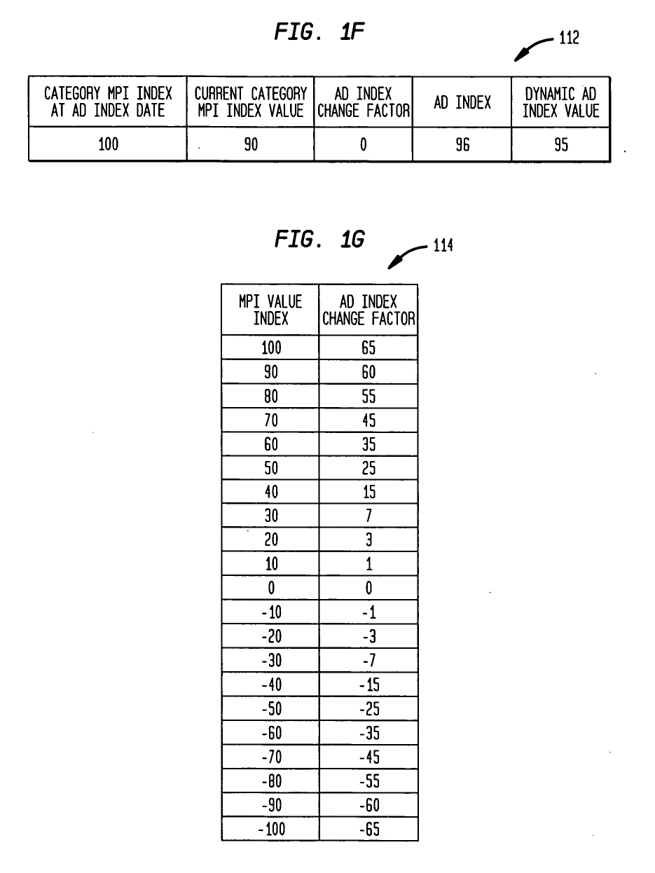

Turning to FIG. 1D through FIG. 1H, depicted is a summary of an example API calculation according to the principles of the present invention. Specifically, FIG. 1D depicts advertisement campaign summary table 108 showing a series of advertisements for a particular product “X” offered and advertised by sample Company XYZ further defining the preliminary stages of the API calculation for the advertisements in various media forums. For reference, each advertising event, or communication record, is defined as a result of the data capture record and is provided an identification number as depicted in the third column. In the example in FIG. 1D, four advertising events are addressed for the particular campaign. The first and second advertising campaigns occurred in print media type and were entitled “Choose 2 or 3 for $5”. Each of these print advertisement events were run in two different markets, specifically Chicago and New York. The first advertisement was offered in the Chicago Tribune and the second was offered in the New York Times. Since each advertisement event was offered in print media on the particular date identified, run time is not applicable to the identified data capture. A further feature of the data capture is identified as Ad Unit and in these instances Ad Unit was run as a 5 inch wide by 2 inch high advertising unit. The third and fourth advertisement events in the present example each represent individual television campaigns entitled “Your Choice” offered again in New York and Chicago and on regional media vehicles (i.e., specific regional television channels). Each of these television campaigns were offered on the same date as the print campaigns and each television campaign occupied thirty second segments during specific morning hours. For each event depicted in FIG. 1D, Spend Data is assigned as the market value for an advertisement of that length on the media source at the designated date and time (i.e., the likely cost of the insertion of that advertisement in the particular medium. The Ad Index (further defined in FIG. 1F and FIG. 1G, supra), a dynamic calculation of the advertisement based on the news environment (i.e., a function of MPI), is assigned to the advertisement event. By multiplying the Spend value of each event by the event's respective Ad Index and further dividing this result by a standard of 100, the API is achieved for each particular event. As mentioned, the API, or Advertising Prominence Index is, in short, the API is a unique metric which combines advertising spending for a single campaign (or multiple events of a campaign) and occurrence data and further weighs the combination to determine the impact on a targeted viewer or the impact of an advertising campaign against competitors' campaigns. Once the API is assigned, the date of the calculation is identified. Clearly, one of ordinary skill in the art will readily recognize that the date of the calculation is highly relevant, as the API is a function of a value at a specified point in time and may fluctuate based on market conditions as it is a function of the Ad index which directly correlates to the MPI (i.e., negative news as reflected in the MPI correlates to a negative Ad Index Change Factor). For reference, the Category MPI at Ad Index Date is identified. This indexed value reflects the total MPI for the specified category of this particular advertisement (e.g., telecommunications, automotive, pharmaceutical, political sector, food service, entertainment, etc.) on the date the Ad Index was initially calculated.

Turning next to FIG. 1E, depicted is Ad Calculation Index table 110 showing the Ad Calculation Index for the particular advertising campaign of product “X” offered and advertised by sample Company XYZ, as identified and analyzed in FIG. 1D, based primarily on a consumer panel evaluation. Ad Calculation Index table 110 is a raw value presentation of the percentages of the respondents from a consumer panel charged with the task of evaluating at least one advertisement and assigning such particular advertisement a positive value for a designated advertisement characteristic. For example, fifty percent of the respondents on a particular panel deemed the reviewed advertisement of Company XYZ “Easy to Understand.” Other advertising characteristics are presented to the consumer panel and the respective positive answers are identified and charted. The raw percentages for each respective advertisement is compared against known values of answers to questions across all advertisements of a particular campaign, series of campaigns, and/or competitor campaigns generating as an index value versus all advertisements. Based on the desired objectives of a particular advertising campaign, one or more of these indexed values are combined and weighted to generate an Ad Index which is utilized in a manner as defined in FIG. 1D, infra. In this particular example, the Ad Index is calculated as an average of the “Know Advertiser,” “Any Call to Action,” and “Better/Worse” values. Thus, the index value reflects the average of the addition of 78, 110, and 100 yielding an Ad Index of 96 as identified in the final column of Ad Calculation Index table 110. While the mere average of certain advertisement characteristics are utilized in the present example, one of ordinary skill in the art will readily recognize that a multiple of indices, weighted in varying increments, can be calculated based on the objectives for a particular advertisement campaign. For example, a company may elect to set a greater weighting to the “Any Call to Action” value if the company's objective in producing the advertisement campaign is to generate increased sales activity for the desired product. Similarly, if a company's objective in producing the advertisement campaign is to improve its image, the company would likely elect to attribute a greater weighting to the “Better/Worse” value.

Turning now to FIG. 1F and FIG. 1G, depicted is Dynamic Ad Calculation Index table 112 for a particular advertising campaign of product “X” offered and advertised by sample Company XYZ reflecting change in Ad Index based on news environment and MPI index and correlating standard Ad Index Change Factor table 114 for calculating the Dynamic Ad Calculation Index for a particular advertising campaign. Dynamic Ad Calculation Index table 112 and Ad Index Change Factor table 114 further define the relevant values depicted in FIG. 1D, infra, for the specified advertisement campaign of Company XYZ.

As previously acknowledged, the Ad Index changes based on the news environment and as a result retesting of each advertisement at regular intervals is conducted so that a real time or recent value is attributed to the campaign. As one of ordinary skill in the art will readily recognize, such constant reevaluation can be daunting and impractical. Thus, in lieu of constant reevaluation, it is an object of the present invention to provide an algorithm that projects the Ad Index value and modifies the Ad Index value at regular intervals. Particularly, the present invention employs a measure of the overall news environment for the category of the advertising based on the MPI values for the category. For example, an advertisement was evaluated and was measured to have an Ad Index of 100. Two months later, highly negative criticism of the entire industry related to this advertisement is apparent. The advertisement campaign from two months ago is still running, unmodified and at the same cost, in the current criticized environment. However, as measured today, the Ad Index as a result of this negative news environment is now calculated as 60 instead of the original 100, meaning it is less successful in providing the desired impact on its audience. The revised Ad Index of 60 can be estimated by comparing the category MPI for the category on the date the initial Ad Index was obtained versus the MPI for the category on the new date that the advertisement was run. The algorithm that enables this estimation without constant and expensive repetition of the Ad Index methodology is obtained through regression analysis and data modeling, but is primarily based on a differential measure of the news environment.

As a further example, a restaurant chain, typically exhibiting a dynamic advertisement index of average (i.e., 100 in the present embodiment) for all advertisements within a particular campaign will likely experience a sharp decline in advertisement impact as a result of negative news coverage. Specifically, as a result of immediate negative news coverage related to bacteria-laden food offerings, the restaurant chain now experiences a dynamic advertisement index of 50 in current identical campaigns. Thus, if the restaurant chain historically expended $40,000,000 on advertising campaigns, generating $40,000,000 in advertising impact, it will now realize that the same expenditure merely yields $20,000,000 in advertising impact.

Similarly, in another example, a new electronic device offered by an electronic conglomerate experiences a highly-effective advertising campaign and achieves a dynamic advertisement index of 120. Interestingly, the electronic device also receives substantial media coverage and favorable reviews, the identical advertising campaign may achieve a dynamic advertising index of 150, resulting in a much greater advertising impact realized. Thus, the metrics of the present invention clearly acknowledge the increased impact when integrating the effect of this successful advertising campaign with the successful media news environment coverage.

Still referring to the Dynamic Ad Calculation Index table 112 of FIG. 1F, the primary factor for influencing the Ad Index is the overall news coverage for the category which is expressed as MPI. The raw MPI value is indexed for the category over time. In the present example, a value of 100 is chosen for the category MPI value when the first advertisement in that category is captured and indexed from the initial baseline value over time. By establishing the current category MPI Index value and comparing this value to the MPI Index value when the Ad Index was initially calculated, an Ad Index change factor can be identified. Specifically, as identified in Ad Index Change Factor table 114 of FIG. 1G, a relationship set is prescribed for establishing the Ad Index Change Factor. In this example of the present invention, a possible set of relationships between MPI Value Index and Ad Index is identified. This data set suggests that the Ad Index is impacted by ±1 point when the MPI Value Index changes by ±10 points.

For example, the initial MPI Index as identified in the first column of Dynamic Ad Calculation Index table 112 when the Ad Index was first calculated was 100 and the current value is 90. Selecting the data points from the chart to the left, a −10 point difference produces an Ad Index Change Factor of −1 and a Dynamic Ad Index Value of 95.

Turning next to FIG. 1H, depicted is Dynamic Ad Effectiveness Index for a particular advertising campaign of product “X” offered and advertised by sample Company XYZ reflecting relative Ad Index Values relative to news environment during different time periods over various media forums. Specifically, FIG. 1H reflects an expansion of the advertisement campaign represented in FIG. 1D, infra. Expanded Advertisement Campaign Summary table 118 represents two additional advertisement events as compared to Advertisement Campaign Summary table 108 of FIG. 1D, infra. These two events, featured three months after the original advertising campaign previously identified, occurred again in print media type in the Chicago Tribune and New York Times. While the majority of the data capture is similar to the previous advertising events as the same advertisement was presented in the forums, the change in the current MPI is apparent

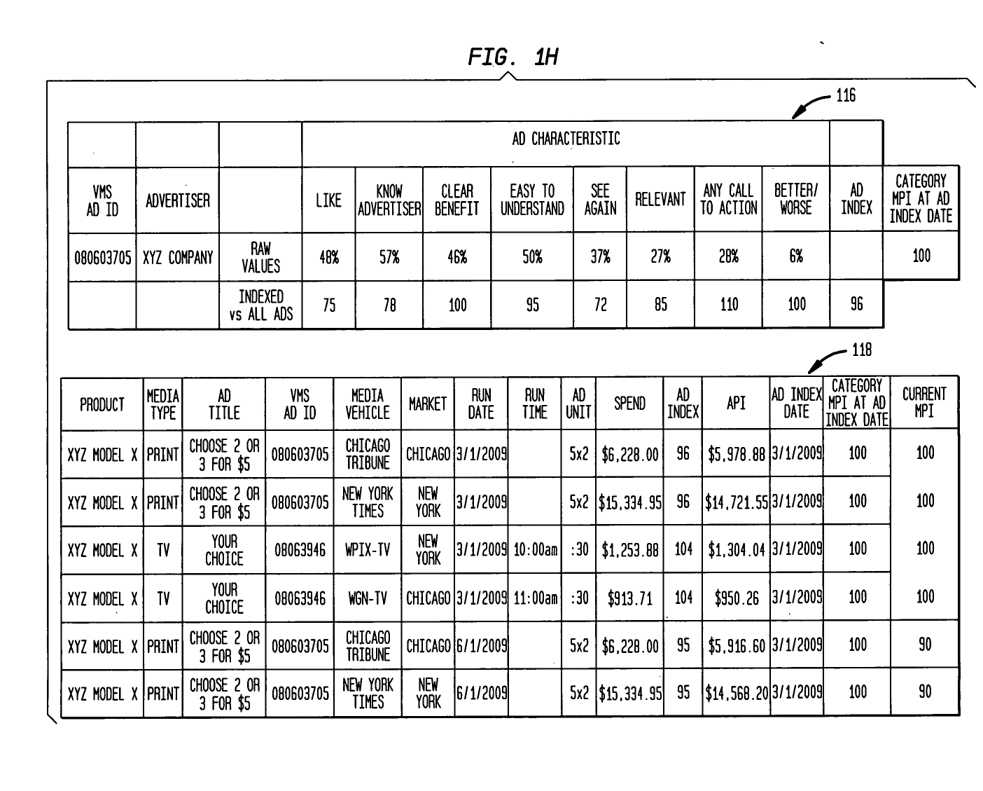

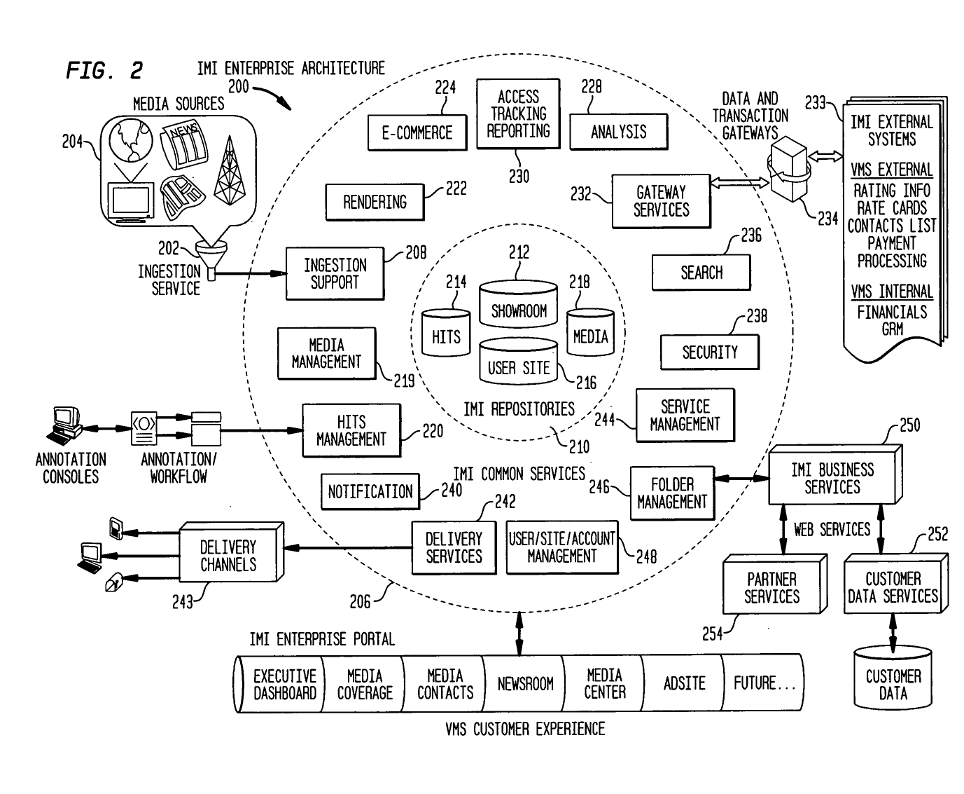

Turning next to FIG. 2, depicted is a block diagram illustrating example enterprise architecture 200, including components and processes, provided in accordance with a preferred embodiment. As shown in FIG. 2, a specialized ingestion process 202 preferably processes and annotates media content being supplied by media sources 204. Media sources 204 include all sources, channels, mediums, and forms of information transfer, conveyance, cultivation, expression and may include, but is not limited to international, national, and regional sources of broadcast, print, internet, news, editorial (traditional and consumer-generated), public relations and press releases, and advertising media such as television, radio, news, magazine, internet, etc. capable of delivering media in printed form, electronic form, or otherwise. One of ordinary skill in the art will readily recognize that media may be conveyed to ingestion service 202 via various public, private, and/or government sources (e.g., purchased from third party clipping services, delivered from a customer, etc.) or acquired through independent research or data gathering services. Ingestion service 202 preferably filters the streams of media items from media sources 204 in order to determine which items are of interest to customers. Items for which no customer is deemed to have an interest are preferably discarded, while content items that are selected as “interesting” (e.g., items which have an impact or a specified degree of relevance) to a client are preferably processed by the ingestion process 202. Content from media sources 204 is preferably reviewed and modified, for example, to correct existing metadata (e.g., correct errors in closed-caption text) and optionally to create additional metadata, such as an abstract, which may be attached to the media item. Preferably, customers may also add metadata, such as content rating values, as a function of architecture 200. Customer annotation is preferably available at an application level rather than via ingestion process 202. Preferably, metadata added during ingestion process 202 can be client-specific, such as rating and tone values with respect to a particular client-specific subject. This allows custom data to be stored for clients with respect to respective companies and industries. Also, customers may modify the data and those modified changes can be captured and utilized to “teach” the system to conduct future modifications of similar nature without user intervention (e.g., thereby “teaching” the system what content is undesired, capture changes in weighting or estimates as to tonality, etc.)

While metadata can be added during ingestion process 202 as a result of the identification of messages and topics present in a news article, advertisement, blog, or other communication using keyword and computer clustering tools as well as human analysis, the presence or absence of a message or topic can also be utilized to filter or select items based on the message or topic. For example, client-specified messages can be very direct, such as “Beverage A quenches your thirst” or more amorphous, such as “Product X improves your inner beauty.” Thus, the present invention is designed to enable users to quantify the level of advertising, news, or other communications by message and also determine the co-occurrence of multiple messages for all communications activities and all media types. The need for this interaction is apparent as many messages exist simultaneously and often are not synergistic. An advertisement may be touting the prestige and exclusivity of a company's sports car while another communication may present a high-end station wagon as affordable luxury. In this example, the station wagon message positions the company very differently than the sports car message. As another example, the advertising message from an oil company that wants its viewers to consider them environmental champions of clean energy conflicts with the news coverage of record fines for fouling the environment as a result of recent oil spills. Thus, the present invention is designed to enable its users the ability to manage these diverse messages and determine the impact of such conflicting messages.

Also shown in FIG. 2, common services 206 include a set of components that may be used by multiple applications as well as by other common service components. Preferably, common services 206 are formatted to be reusable, thereby providing benefits of reusable code, as known in the art. Furthermore, common services 206 are preferably formatted as modular components that provide for convenient enhancements and modification for future adaptations.

Common services 206 also provide a basis for implementing a service oriented architecture (SOA), which, as used herein, generally refers to a software architectural style that achieves loose coupling among interacting software agents. Preferably, utilizing a SOA provides a sustainable solution that consolidates components of the architecture's value chain and delivers a modular, componentized solution for the future.

In a preferred embodiment, common services 206 include ingestion support 208 that provides an interface between ingestion service 202 and IMI repositories 210. IMI repositories 206 preferably include databases that store information by common services 210 and associated data applications. IMI repositories 210 preferably operate at the core of common services 206 platform and provide a storage area for storing, modifying and accessing data.

Preferably, external systems use a service layer, such as an application programming interface layer, as known in the art, to access IMI repositories 210. Also preferably, IMI repositories 210 include showroom repository 212, hits repository 214, user site account access repository 216 and media repository 218. Hits repository 214 and media repository 218 preferably include data related to such assets. Showroom repository 212 preferably enables subscribers to create customized showrooms for on-line “guests.” As used herein, a “guest” represents, generally, a type of user account that is associated with a parent account, typically a subscriber user account. Guest users, typically, are entitled to read-only access to showrooms, which are defined by media center 218 subscribers. Furthermore, the user, site, and account 216 repository preferably contains data for the management of these common entities. Further, common services 206 include media management 219 and hits management services 220 that provide management and access to media content items, including associated metadata, which are preferably stored in the repositories 210. As used herein, “hits” stored in hits repository 214 preferably refer to content that matches a client's interests. For example, hits are generated as a result of keywords/threads and/or notes which provide detailed instructions about hits a particular customer wants and does not want. For example, a customer may define rating/toning instructions, thread definitions, section definitions, issue definitions and track groups, competitors, major media, major regions, publishers, score groups, campaigns, and publishing cutoff times.

User account access repository 216 preferably enables a user to define various levels of data access for users. For example, access repository 216 enables a user to create a guest user, edit guest user attributes and delete a guest user. Further, access repository 216 preferably provides the ability to create a subscriber user, edit user attributes, and delete a subscriber user. Other features include the ability to create a master subscriber user, and to edit user attributes and delete a master subscriber user; the ability to create a partner ASR user, edit the ASR user attributes and delete the user; the ability to create a VMS ASR user, edit the VMS ASR user attributes and delete the user; the ability to create a master ASR user, edit the master ASR user attributes and delete the user; the ability to create a site, edit its attributes and delete the site; the ability to create an account, edit the account attributes and delete the site; the ability to associate a site with an account; the ability to associate a user to a site, edit the attributes for this relationship and disassociate a user from a site; and the ability to grant management access for a site to another user. The result is that the specified site becomes part of the management scope of the designated user. Further, access 216 preferably provides the ability to grant management access for an account to another user, the result is that the specified account becomes part of the management scope of the designated user; and the ability to grant management access for a user to another user. The result is that the specified user becomes part of the management scope of the designated user.

Preferably, a user is only permitted to manage (e.g., edit attributes or delete the entity) an entity (e.g., a user, site, account) for which the user has management authority. By default a user preferably has management authority for all entities which are created by that user. In addition a user may be granted management authority to an entity.

Continuing with reference to FIG. 2, rendering services 222 provide a framework to render media assets with the ability to transform a content item (e.g., a “hit”) from the item's form or representation into another form. For example, rendering services 222 are used to render a selected set of hits from raw data into a report. As used herein, the term, “rendering,” refers, generally to the ability to transform a content item, or a collection of content items, from a first form or representation into another form or representation. For example, a list of hits may be rendered to be displayed in HTML, for viewing on a web page. Alternatively, the list may be rendered to be formatted in ADOBE PDF format, MICROSOFT MS-Word (.doc) format, or, alternatively in a format for a respective e-mail client application. Rendering preferably applies to all content types within the architecture 200 including, for example, news items, editorial items, advertisements, broadcast content items and internet-source content items.

Thus, various types of rendering are envisioned herein, including, for example, rendering a set of content items into HTML for browser window display, rendering a set of content items into a text-based email message, rendering a set of content items into an MS Word .doc file, rendering a set of content items into a PDF document, and rendering a set of content items into a media center showroom for viewing by a guest user (described above). E-commerce services 224 provide facilities to support online sales of products, such as media clips and video segments.

Moreover, reporting and analysis services 228 offer an ability to provide analytical data to customers using a variety of reporting formats and tools. As used herein, “reporting” and “analysis” are treated similarly in architecture 200, thereby enabling users to produce various reports, including charts, graphs, and spreadsheets, for example, for analysis. Further, access tracking and reporting services 230 offer the ability for users to track access to web-based resources and generate access reports. This preferably enables a media center subscriber to monitor who has accessed a particular showroom and the content that was viewed. Furthermore, gateway services 232 provide facilities for integrating systems 233 that are external to common services 206. In a preferred embodiment, gateway services 232 map an account number in a first account to an account number in one of the supported external systems. Moreover, gateway services 232 preferably retrieve selected account information from supported external systems. This information is used, for example, to pre-populate a new account, or to validate account information against an external system. For example, financial systems (e.g., that are internal to a proprietor of the present invention), as well as payment processing services and data-related services (e.g., feeds of ratings information, media contact information, or the like), that are external to a proprietor of the present invention are supported. Preferably, a tight coupling exists between gateway services 232 and a related data transaction gateways 234 component. Respective implementations of architecture 200 preferably determine the particular structures of gateways 232 and 234, as well as multi-tiered approaches therefore.

Continuing with reference with FIG. 2, search services 236 include a set of components that provide comprehensive and customized search capabilities to applications seeking media assets in IMI repositories 210. Moreover, security component 238 preferably provides fundamental security functions, such as authentication and authorization. Although security component 238 is illustrated in FIG. 2 as a common service, it is to be understood that security component 238 is pervasive throughout the common services 206 and IMI repositories 210. Additionally, notification services 240 preferably provide general facilities for sending various types of notifications and other information to users, customers as well as to internal personnel. As used herein, notifications preferably include email/fax distribution of reports and delivery of alerts to customers.

Also shown in FIG. 2, delivery services 242 preferably provide support for the delivery of various products, services and notifications, as taught herein, through various delivery channels 243. Products and services preferably include the delivery of various reports, typically via email, as well as the delivery of products purchased on-line such as video segments and advertisements. Various common delivery channels 243 are supported by the present invention, including, for example, electronic delivery (email, fax, download) and physical commercial delivery. In addition, all technology disclosed herein is designed to work in concert with common electronic devices currently available, as well as future electronic devices capable of displaying the user information disclosed herein. Specifically, such devices include, but are not limited to cellular phones and electronic digital assistants operating on a plurality of transmission networks. Various parameters for the transmission of the user information disclosed herein can be set by the user, administrator, by default, etc., including alarms, immediate automatic download, delayed reporting, etc. In addition, transmissions can be automatically sent to other programs through direct links, RSS feeds, or authorized requests from such other programs or links. It is also contemplated by the present invention that the unique data transformations enabled herein will be made available as input to other programs, such as forecasting, Electronic Marketing Management (EMM), or custom applications, either external or internal to user facilities.

Moreover, service management 244 includes a set of functions which support operations in architecture 200, including functions for supporting information technology (“IT”) service management and planning functions, such as capacity management, performance management, and availability management. This preferably includes features such as operational event tracking and notification, instrumentation of various services and the capture of metrics to support IT service planning and management activities. Additionally, folder management component 246 preferably includes a centralized ability for a user to manage folders (e.g., company folders, personal folders, or the like) while working with one or more applications. Preferably, users can create folders and add items (e.g., hits, and articles) to the folders. Additionally, user, site, and account management component 248 provides facilities to create and manage customer accounts and customer sites for hosting media content and users who access these sites. For example, component 248 enables a user to define what a user can (and cannot) view on a site (e.g., issues, publishers), particular reports and analysis a user is authorized to access, and features a user is granted access to, such as a scorecard.

Continuing with reference to FIG. 2, business services 250 extend services to provide various benefits, including to develop and support a wide market of customers, an increased market share, additional products and product suite services, increased name and branding services, an increased customer base, and additional revenue from patrons and new customers. Hence, services 206 support the implementation of strategic services for customer data services 252 and partners 254.

For example, a public relations (“PR”) agency offers various PR-related services to the agency's clients. The PR agency contracts for content services from a proprietor of the present invention to allow the agency to obtain various news and editorial content from through various interfaces, described herein. The content is preferably packaged by the PR agency and re-sold to the agency's customers. Business services 250 preferably extends media content to a wide variety of service offerings, and is preferably available through well-defined, standards-based interfaces (e.g., web services). For example, business services, perhaps based upon standard web services protocols, preferably accesses data hosted by systems owned by a customer, and the data is preferably included in advanced analysis scenarios including, for example, campaign response analysis.

Thus, and as illustrated in FIG. 2, a plurality of components, services and processes are supported and/or provided that operate via enterprise architecture 200 in accordance with the teachings herein.

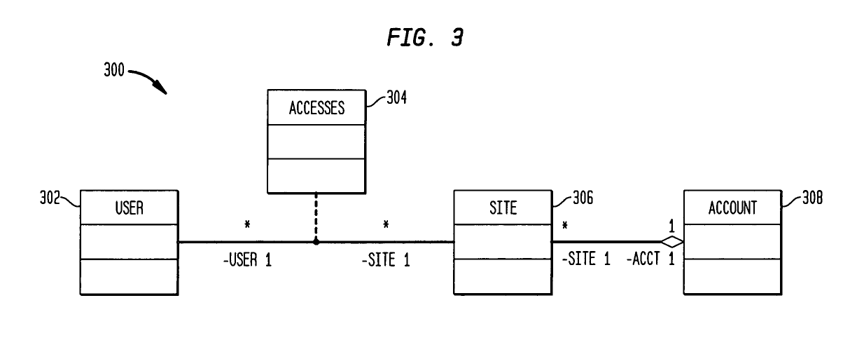

FIG. 3 is a unified modeling language (“UML”) class diagram, as known in the art, illustrating relationships 300 of users to sites, and sites to accounts. As shown in FIG. 3, a user-site relationship is shown representing a relationship in which a user 302 accesses 304 a site 306. In a preferred embodiment, the relationship is defined as a “many-to-many” relationship, in which a user 302 may access 304 many sites 306, and a site 306 can be accessed 304 by many users 302. The user-site relationship preferably holds attributes that specify respective permissions a user 302 has for a particular site 306.

Continuing with reference to FIG. 3, an account-site relationship is illustrated for a relationship in which an account 306 “covers” a site 308. In a preferred embodiment, the relationship is defined as a one-to-many relationship, in which a single account 308 can cover multiple sites 306. The practical implication is that a single account 308 will be billed for all sites 306 that that account 308 covers. In addition, the site 306 is preferably associated (i.e., it “depends”) on the account 308.

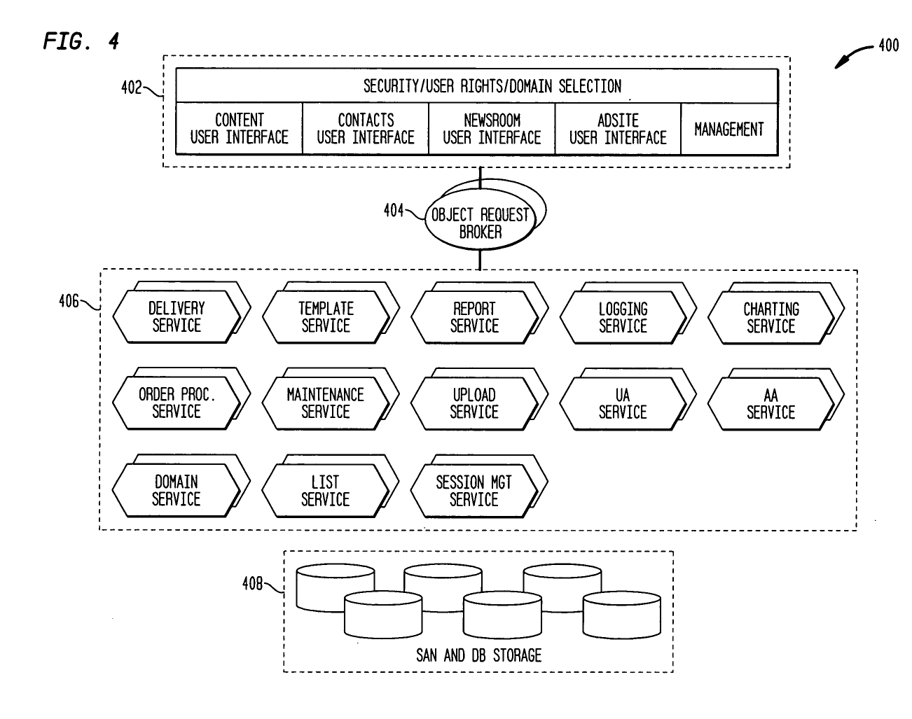

Furthermore, a redundant, distributed architecture is preferably provided, including scalable systems and services. FIG. 4 is a block diagram representing a graphical view of an architecture 400 implemented in accordance with an embodiment that resembles at least in part architecture 200 (FIG. 2). As shown in FIG. 4, four partitions are illustrated that include security/user rights/domain selection interfaces 402, an object request broker 404, a plurality of templates and services 406, and a storage area network (“SAN”) and database (“DB”) storage 408. The interfaces 402 include interfaces for content, such as INSIGHT CONTACTS, NEWSROOM, ADSITE and APEX, offered by the assignee of the present patent application. Object request broker 404 preferably manages data object requests from the respective interfaces to and from various services 406, including for content delivery, templates, reports, logging, charting, order processing, maintenance, uploading, user attributes, application attributes, domain service, list service and session management services, as described herein and/or known in the art. Data provided in connection with the services are preferably stored in storage 408.

As illustrated in FIG. 4, data storage 408 is an integral element of the present invention. Storage of physical files is preferably organized on a SAN such that the visibility of content and access to files is organized by site. Public access to files is permitted via service calls that carry an appropriately formatted and encrypted token, which will identify the user who published the information. Absolute file locations are preferably managed by the object request broker such that calls to the object request broker identifying the site, item_image_id, and session_id or public token will resolve to produce a full URL for the resource.

As used herein, the term “application” refers, generally to a discreet collection of services and templates as presented in a user interface for a specific business function for a given site. By way of example INSIGHT CONTACTS, offered by the assignee of the present invention, is an application, as is ADSITE 4.0.

Templates are provided that are preferably formatted as cascading style sheets and present objects, other templates and call services in a user interface for a given application. Templates are preferably reusable across sites and applications. Templates manage the transparency for the objects they contain and the access to services presented based on permissions derived for the specific instance of a session, user, site and application. Templates also preferably support embedded server and client side scripting and address formatting issues in presentation form such as table/cell width, fonts and sizing etc. Initial template types include pages, menus, lists, charts, and items.

Page templates are further provided and displayed in the main well (i.e., a portion of a page template) or via pop up display screens and support menus lists, items, data elements, functions and services calls.

Master Page templates comprise a header, main well and toe line. Each site preferably has only one master page associated with it. The header preferably contains customer branding, a quick search form, and advanced search link, and an application selector if the user-site for the current session has permissions for more than one application.

The object request broker is preferably a rules-based traffic manager that knows where services or data are located and routes and resolves requests for the services transparently to the application. This facility addresses load balancing, redundancy and SAN storage while freeing resources for performing maintenance without resulting in down time by shifting service or data calls to redundant servers.

Objects are essentially the raw elements presented in the user interface. Objects include menus, forms, links, data, service calls, template calls, and referenced elements such as images or video clips.

Sites are logical collections of applications, users, and data specific to a given account. For example, DELL COMPUTER might have a site with ADSITE, INSIGHT CONTENT, and CONTACTS supporting two hundred users with two years worth of content.

Services represent the underlying processing and functionality supporting activities on sites. Ingestion, indexing, and template rendering are all services. Such services may or may not have an associated user interface, as appropriate.

Sessions preferably reference a specific user session for a specific site. Sessions also manage dynamic lists or the state of a given user from page to page. A session is initiated for each user when logging in to a site.

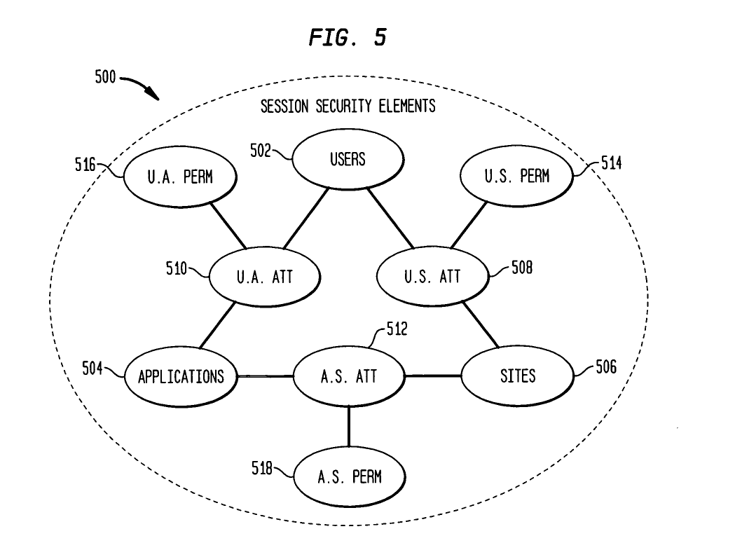

FIG. 5 is a chart illustrating session security elements 500 that are defined in accordance with a preferred embodiment. Preferably, security and user rights are central elements of this package and are provided for a plurality of data sources, such as database tables, and the security and user rights preferably support a need for both federated login pages and branded, site-specific, login pages. On logging in from the federated login, users with access to more than one site are preferably prompted to select a site on which they would like to work. Those logging in through the federated page with access to only one site are preferably directed only to a site for which they are authenticated. Users logging in through the branded login pages are preferably directed to a respective site associated with the login page. Upon a successful login, the present invention initiates a “session” for the user on the particular site accessed with the permissions appropriate to that specific instance of user and site. Preferably, a secured communications protocol (e.g., “HTTPS”) is used for any communication session in which passwords, orders, or proprietary information are collected or displayed, as well as when any proprietary or personal information held on the site such as credit card numbers.

Structurally, the permissions for a given user for a given site and/or for a given application are preferably interdependent and established during the log in process as a site is selected. As the list of permissions for each of these elements increases over time, the definition of permissions is preferably driven through table entries for each of three permutations: user 502, site 504 and application 506, as desired. Provisions are preferably made to insure that client content is not publicly available or visible to users of other sites unless the end user has elected to publish the data in some manner.

In one embodiment, a data table is preferably provided that represents users 502, and rows of the users table preferably contain elements common to a user across all instances of a sites and applications. For example, data elements may include: user name, e-mail address, alert e-mail address, password, credit card information, and contact information. Further, a data table is preferably provided that represents sites 504, and rows of the sites table preferably contain data elements explicit to a respective site regardless of the user or application being utilized in a given session. For example, data elements in a sites table may include: site name, logo, content feed ids, login page, HTML page name values, volume limits, and site content repositories. Furthermore, a data table is preferably provided that represents applications 506, and rows of the applications table preferably represent various IMI applications and tiers of services. For example, data elements in the applications table may include: application name, service level, trial site, and pointers to help documents.

The user-site attributes (“U.S. Att”) table 508 preferably comprises rows of data that join users to sites and identify the associated permissions in “user-site” permissions granted to a given user for a given site along with any modulating variables or arguments. These permissions preferably control the transparency of the associated objects and services for a given user/site session. The U.S. Att table preferable includes four fields; user_id, site_id, user_site_permissions_id, and arguments.

The user-application attributes (“U.A. Att”) table 510 preferably comprises rows of data that join users to applications and identify the associated level of service subscribed to for a given user on a given site. These permissions preferably control the transparency and nature of access for a given application for a given user/site session.

The application-site attributes (“A.S. Att”) table 512 preferably comprises rows of data that join sites to applications and identify the associated level of service subscribed to for a given application in a given site. These permissions preferably control the transparency and nature of access for a give application for a given user/site session.

The user-site permissions (“U.S. Perm”) table 514 preferably includes rows of data that identify tunable permissions applicable to users and sites. For example, data elements include: Can Order QV, Can Order Tape, Can Edit Segments, Can View MPI, Can Application Name, Service Level, Trial Site, and pointers to Help Documents.

The user-application permissions (“U.A. Perm”) table 516 preferably includes rows of data that identify tunable permissions applicable to users and applications. For example, data elements include can distribute, read only, disable use, trial account, application visible, and display advertisement.

The application site permissions (“A.S. Perm”) table 518 preferably includes rows of data that identify tunable permissions and attributes applicable to sites and applications. For example, data elements include can distribute, image storage length, read only, disable use, trial account, application visible, and display ad.

The transparency for some elements may be controlled by more than one value from one or more of the attributes tables.

In practice, the session management service preferably logs user and site activity including page displays, last login, errors encountered, orders placed and processed as well as other features requested by embedding a “logging” function call in a page display. Logging records are preferably stored in a respective table and include three types: accumulated records (e.g., page displays, orders placed, or e-mail's sent), transactional records (e.g., error messages and credit or service requests) and transitional events (e.g., last login, last edit, last report distribution). Logging classifications are preferably stored in a respective table, including an id field, description, and type id. Logged events preferably reside in a joined entity and identify insert date, update date, session id, user id, site id, application id, log event id and log event type and a description field passed by logging function calls.

Once a user provides a valid user id and password, and selects a site, the session manager preferably establishes appropriate permissions for that session and launches the master page template and display page identified in the user-site attributes table. A facility for e-mailing forgotten passwords is preferably available from a login page and any resent passwords are preferably logged. While password management services may not be required, one skilled in the art will recognize that the architecture supports such services, if desired.

Preferably 128-bit encryption is supported and separate key sets are generated at both the site and user level. Confidential fields such as credit card numbers and sales projections are preferably encrypted and stored in a database. Users uploading content to a site also preferably have the option of applying site or user specific encryption. Additionally, all “put” transactions are preferably provided via the HTTPS communication protocol.

Further, various “common services” are supported that include a set of reusable components supporting the entire IMI infrastructure. The activities supported by these services are preferably compartmentalized to the greatest extent possible to more readily support enhancements and future modifications.

In one embodiment, the present invention provides an alerts/triggers service to launch exception reports, monitor system performance and initiate client and account services notifications based on timed or event based activity against user-defined events. Examples include alerting clients at regular intervals to new news coverage posted to their sites, advising support staff of content that could not be properly ingested or advising sales staff when an account exceeds an anticipated run rate.

In another embodiment, a charting service is preferably provided to render charts that “tunnel down,” as known in the art, to lists of the supporting coverage for display and inclusion in larger reports.

A delivery service option is preferably provided to support the delivery of user-generated material. The service preferably monitors and tracks the delivery status for a given transfer to the greatest degree possible and logs the information as appropriate and tracks and reports exceptions. Protocols supported preferably includes E-mail, RSS, FAX, HTTP, MMS, FTP and “pod casts,” as known in the art.

Further, an order processing service is preferably provided to support electronic ordering of services. This service preferably supports both account-based purchases and credit card orders as determined by the permissions established for a given user on a given site. Fulfillment for some “orders” such as audience values or QV previews will be completed automatically and other item may require physical delivery. The order processing service preferably supports a traditional shopping cart purchase with pricing from the sites table. End users are preferably able to track the progress of their orders through this process as well. The initial life cycle for orders are preferably “pending”, “in process”, and “delivered” but the definitions for this lifecycle are preferably table based and tunable by product. The order processing service also preferably initiates site based notifications of new orders via the delivery-service and export order information to backend billing and OEOP systems such as pilot.

A maintenance and management service is an internal service supporting a proprietor of the present invention and related staff in administering the system as a whole. This service preferably provides user and site management statistics including exception reporting. This service further manages user and site account information and template selection and the other values necessary to initiate and manage an account. This service preferably conducts and monitors account based maintenance activities such as purging content, creating archive CDs and cleaning out expired data. The service preferably supports a proprietor of the present invention and related staff in administering the system as a whole by collecting and tracking user and site management statistics including, for example, exception reporting and allowing for support staff to manage and track user and site account activity such as usage, template selection, session values, and other system values as necessary to initiate, manage accounts, and address various issues.

Moreover, a billing service is preferably provided that supports the creation of export files supporting the billing and invoicing for INSIGHT services and content. This service preferably is able to track and manage royalty payments for content as necessary and produce reports of incremental billable activity as necessary. The service preferably also allows customers with appropriate permissions to review the billable activity for their accounts and the status of their accounts. A proprietor of the present invention may be required to provide royalty reports to a number of data providers and accordingly, anticipate growth in the number of suppliers requiring this service over time. Thus, logging and capturing activity is performed and associated with licensed material. This service preferably is able to render electronic billing and royalty reports as well.

In addition, user maintenance is preferably performed in the Maintenance/Management service, and end users preferably have access to a facility that allows them to establish their preferences and configure their sites, provided they have been granted appropriate permissions. For example, data elements are provided for home page selection, default sort order, password, e-mail address, purchasing preferences, and report format preferences. Users with additional authorization, such as “administrative” permissions are preferably able to edit and update these values for other users on their site.

Further, a search functionality is preferably provided. Users are preferably able to search by virtually any piece of metadata associated with content and the richer searching tools are preferably provided. All content is preferably indexed and searchable as it is added to or modified on the site. Preferably, a searching service preferably supports full Boolean and proximity queries, as well as search term suggestion, conceptual clustering, and proximity, positional, and frequency operators. The search service is preferably closely coupled with the database operations, thereby enabling DB and textual queries to be handled in a single consistently formatted service call.

Additionally, content ingestion and data normalization services are preferably provided to manage and process content from third party sources. As such, the ingestion process is preferably extremely robust and flexible. Broadly, the ingestion process preferably collects content in a number of formats via a number of push and pull communication protocols. Based on account information in the feed, the content is preferably processed for delivery to a specific site and information from the feed is preferably normalized against master tables in the application for information like publisher, market, affiliate, city, state and country. This content is preferably subjected to any account-based transformations such as image modifications, market reassignment or automated annotations as identified in the site instructions and stored in the appropriate content repository for display or subsequent processing. Each stage in the article ingestion process is preferably given its own identifier so that the content progress through ingestion can be traced and problems and exceptions are preferably reported and logged by the alerting and logging services.

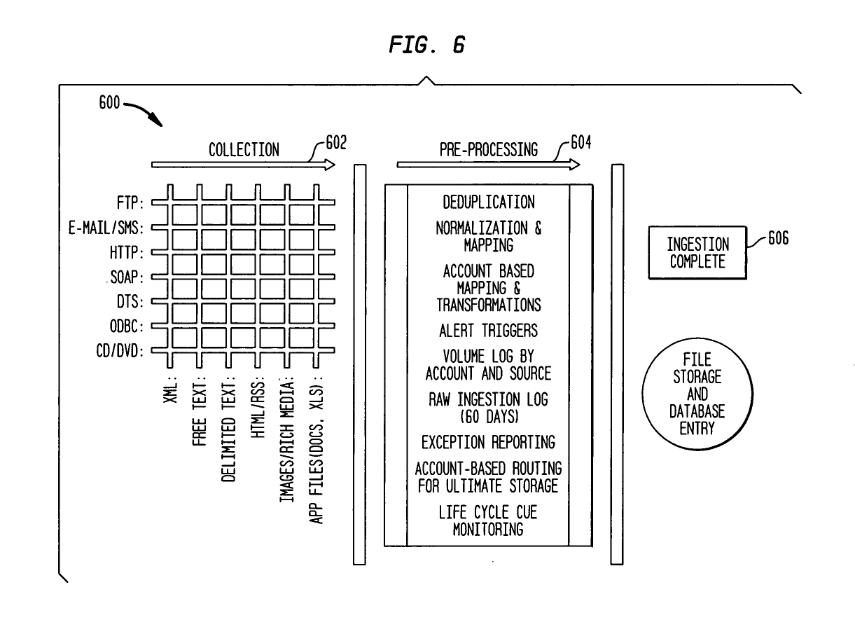

FIG. 6 illustrates steps 600 associated with collection 602, pre-processing 604 and completion of ingestion 606, in accordance with a preferred embodiment of the present invention. Collection 602 of data may occur via various known processes or sources, FTP, e-mail (SMS), HTTP, SOAP, DTS, ODBC, or via reading a drive, including CD/DVD, or other method of data transfer as known in the art. The data may be formatted in various ways, including XML, free text, delimited text, HTML/RSS, images (or rich media), or in formatted application files, such as MS-EXCEL spreadsheet files, or other format as known in the art. During the preprocessing 604 stage, various processes are performed on the collected data. For example, duplicate data are removed, data are normalized and mapped, account-based mapping and transformation occurs and alert triggers are set, as known in the art. Further, a volume log by account and source is generated, as is an ingestion log for a set period of time, such as 60 days. Moreover, exception reporting is preferably provided and account-based routing for eventual storage occurs. Moreover, data lifecycle cue monitoring is provided. Once complete 606, file storage and database entry is performed.

Preferably, users upload their own content and/or data and a manual upload service provides a user interface to the ingestion service. In an embodiment, a publishing service supports editors in the preparation of content for presentation on sites. Moreover, a rendering service may be provided, for example in one or more embodiments for collecting data, templates and objects necessary to populate page as requested in a user interface and, thereafter, to present the information in an appropriate manner through the user interface. The rendering tool preferably updates the session management service to reflect changes in the state of the user session as appropriate.

Preferably, a session management service is responsible for managing the state of a user while they are actively using the application. This includes managing state, user selected lists of articles or shopping carts or the status of reports being rendered through multi page wizards. A utility within the session management service further preferably allows support staff to monitor the state of a given user and any errors that may be occurring in their interaction with the site. Moreover, the session management service preferably identifies multiple user utilizing a single account and conditionally lockout users based on permissions in the user-sites table.

Moreover, a template management service is available for the proprietor of the present invention and corresponding staff to construct reusable template or style sheets for the presentation of information and services on customer sites. These templates preferably allow users to embed other templates in a cascading manner and support the embedding of functions, conditional logic and data elements within the template definitions.

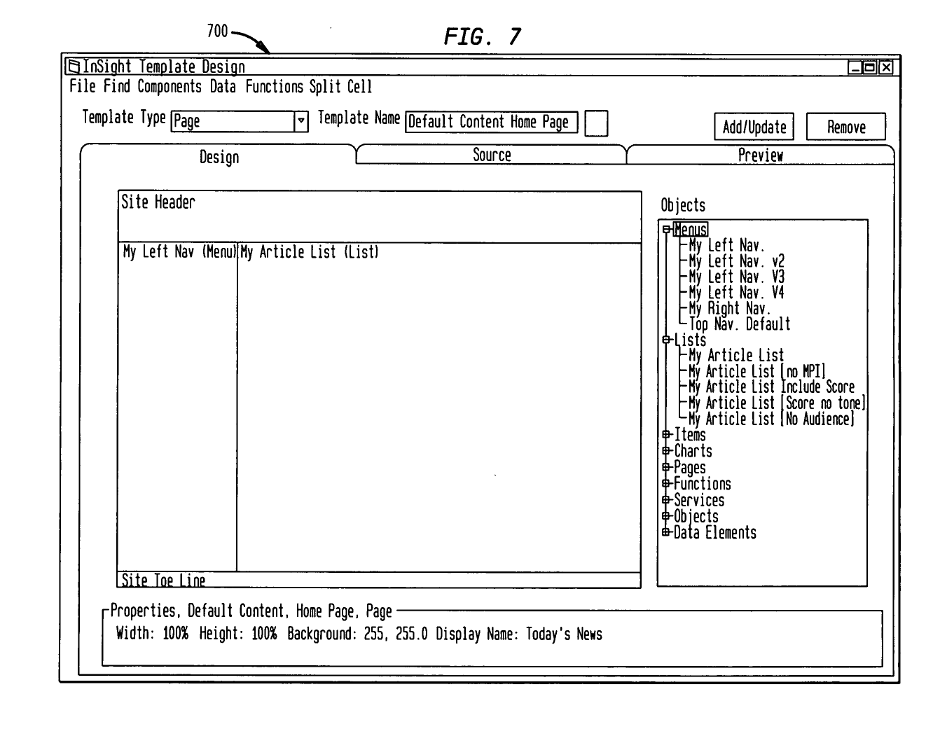

FIG. 7 illustrates an example template management service display screen 700 in accordance with a preferred embodiment. The following describes templates elements thereof that are preferably available via the template management service.

Master Page Templates: These templates include a header, main well and toe line. Each site preferably has only one master page associated with it. The header preferably contains customer branding, a quick search form and advanced search link and an application selector if the user-site for the current session has permissions for more than one application. Selections made by an application selector launch the selected application pages in the main well. The main well initially displays a user defined start page for the site and updates to reflect the user's activity and interaction with the site. The toe line is a status bar/and navigational aid of sorts and preferably cannot be edited.

Page Templates: Page templates are displayed in the main well or via pop ups and can support menus lists, items, data elements, functions, and services calls. They are essentially the “guts” of the active application.

Menu Templates: Menus allow the user to launch pages against target frames and initiate service calls and functions.

List Templates: Lists contain and display data results populated based on the query property. They may be configured to display result sets as full lists or paged results. The items presented are ordered by the fields defined in the “order by” property of the template. Lists can be present items in a grouped or banded report formats based on a “group by” property.

Item Templates: Items are intended to format records of result sets for display and should be able to incorporate conditional logic, functions, and service calls.

Chart Templates: Chart templates preferably address the design and lay out of graphs and charts against lists of data results.

Preferably, objects that are provided in accordance with the template management service include lists, items, menus, actions, icons, and images.

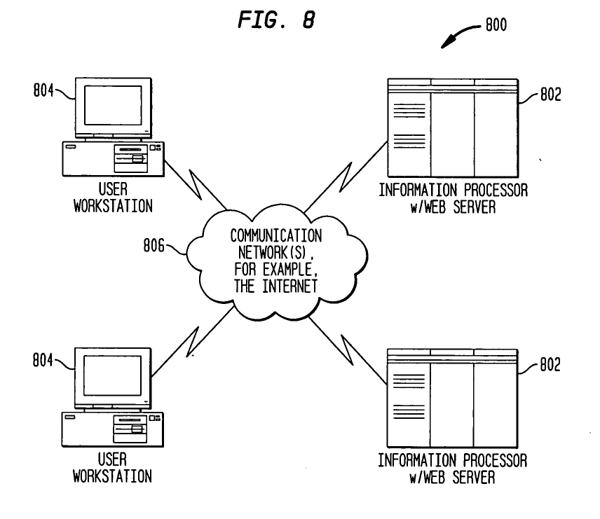

FIG. 8 illustrates an example hardware arrangement, in accordance with an embodiment of the present invention, and referred herein, generally, as system 800. In the example shown in FIG. 8, information processor(s) 802 are operable to function as Internet web servers, as known to those skilled in the art.

Information processor 802 preferably includes all databases necessary to support the systems and methods described herein. However, it is contemplated that information processor 802 can access any required database via communication network 806 or any other communication network to which information processor 802 may be coupled. Communication network 806 is preferably a global public communication network such as the Internet, but can also be a wide area network (WAN), local area network (LAN), or other network that enables two or more computers to communicate with each other.

In a preferred embodiment, information processor 802 and user workstation 804 are any devices that are capable of sending and receiving data across communication network 806, e.g., mainframe computers, mini computers, personal computers, laptop computers, a personal digital assistants (PDA) and Internet access devices such as Web TV. In addition, information processors 802 and user workstations 804 are preferably equipped with web browser software, such as MICROSOFT INTERNET EXPLORER, MOZILLA FIREFOX, or the like. Information processors 802 and user workstations 804 are coupled to communication network 806 using any known data communication networking technology.

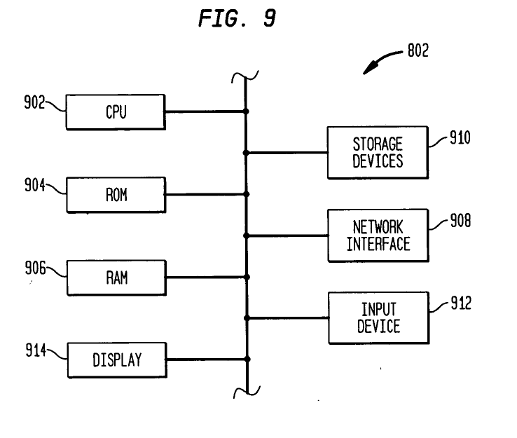

FIG. 9 illustrates the functional elements of an example information processor 802, and includes one or more central processing units (CPU) 902 used to execute software code and control the operation of information processor 802. Other elements include read-only memory (ROM) 904, random access memory (RAM) 906, one or more network interfaces 908 to transmit and receive data to and from other computing devices across a communication network, storage devices 910 such as a hard disk drive, floppy disk drive, tape drive, CD ROM or DVD for storing program code databases and application data, one or more input devices 912 such as a keyboard, mouse, track ball, microphone and the like, and a display 914.

The various components of information processor 802 need not be physically contained within the same chassis, located in a single location, or managed by a singular entity. For example, storage device 910 may be located at a site which is remote from the remaining elements of information processor 802, and may even be connected to CPU 902 across communication network 806 via network interface 908. Information processor 802 preferably includes a memory equipped with sufficient storage to provide the necessary databases, forums, and other community services as well as acting as a web server for communicating hypertext markup language (HTML), Java applets, Active-X control programs, or the like to user workstations 804. Information processors 802 are arranged with components, for example, those shown in FIG. 9, suitable for the expected operating environment of information processor 802. The CPU(s) 902, network interface(s) 908 and memory and storage devices are selected to ensure that capacities are arranged to accommodate expected demand.

As used herein, the terms “link” and “hyperlink” refer to a selectable connection from one or more words, pictures or other information objects to others in which the selectable connection is presented within a web browser software display. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient to accomplish this aforementioned task as well as other “selecting” or “clicking” tasks presented in the present invention.

The functional elements of information processor 802 shown in FIG. 9 are of the same categories of functional elements present in user workstations 804. However, not all elements need be present in the user workstation 804. For example, storage devices, in the case of PDA's, and the capacities of the various elements are arranged to accommodate the expected user demand. For example, CPU 902 in user workstation 804 may be a smaller capacity CPU than the CPU present in the information processor 802. Similarly, it is likely that the information processor 802 will include storage devices of a much higher capacity than storage devices present in user workstation 804. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, and a plurality of web-site development applications.

Although the present invention is described by way of example herein and in terms of a web-based system using web browsers and a web site server (e.g., information processor 802), system 800 is not limited to such a configuration. It is contemplated that system 800 is arranged such that user workstation 804 communicates with and displays data received from information processor 802 using any known communication and display method, for example, using a non-Internet browser WINDOWS viewer coupled with a local area network protocol such as the Internet Packet Exchange (IPX), dial-up, third-party, private network, a value added network (VAN), or any other communication network now utilized in the relevant art, as well as those communication networks with similar capabilities not yet contemplated in the art.

It is further contemplated that any suitable operating system can be used on information processor 802 and user workstation 804, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, WINDOWS VISTA, MAC OS, UNIX, LINUX, PALM OS, POCKET PC and any other suitable operating system.

As used herein, references to displaying data on information processor 802 and user workstation 804 regard the process of communicating data across communication network 806 and processing the data such that the data is viewed on a display 914, for example by using a web browser and the like. As is common with web browsing software, the display 914 on user workstation 804 presents sites within the system 800 and architecture 200 (FIG. 2) such that a user can proceed from site to site within the system by selecting a desired link.

Therefore, each user's experience with system 800 is based on the order with which he/she progresses through the display screens. Graphic controls are preferably available in the display screens and modules to initiate data processes, and to provide convenient navigation between the display screens and modules of system 800. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 800.

Various applications are envisioned herein. For example, one application offers fast access to competitive advertising intelligence across all media and provides comprehensive occurrence and spend data through a fully customizable online content/data management dashboard. The software allows users to organize, manage, report on and distribute competitive ad clips, data and reports easily and efficiently.

Another application is a premium module providing a comprehensive directory of media outlets and contacts. This module is available online 24 hours a day, 7 days a week and includes information from all media and markets—including local and national newspapers, cable, network and local television stations, local radio stations, radio networks, and magazines.

Yet another application allows public relations departments to create, distribute and track coverage from press releases within a single environment and establishes a public site for reporters and other communications professionals to access and download press releases, images, graphics, and other materials quickly and easily from one location.

Still another application provides news monitoring and competitive advertising intelligence integrated across all key media in an executive dashboard tailored to marketing and communications executives. As a result of the correlation metrics developed in the present invention, it has been determined that news environment impact, measured as the MPI, has a substantial influence on the advertising effectiveness. Thus, as described herein, a high MPI value will correlate with a high API value. Similarly, a successful advertising campaign exhibiting a high API value, has a positive impact on MPI. The present invention provides a metric for presenting these basic attributes of the industry. Thus, presented herein is a system and method for measuring the dynamic interrelationship between media prominence and advertising prominence entitled the Integrated Media Index.

As used herein, Integrated Media Index is a unique integrated correlation metric generated as a function of the combination of the API values (expressed as a weighted Share of Voice) and the MPI values (expressed as Share of Discussion). This novel and unique metric, is obtained by combining API and MPI in varying fashions. For example, Integrated Media Index can be a simple addition of MPI and API. Alternatively, API or MPI can be weighted based on a particular industry's response to news or advertising. The weighting of the metrics can be user-specified, industry-specified, etc. to address the particular characteristics of the specific activity. For example, in the financial community there is heavy reliance on independent financial experts to guide investment choices and as a result news activity typically has a significant impact on the industry as compared to a paid advertisement. As a result, in this instance, the news metric utilized to calculate the Integrated Media Index must be weighted greater than the advertisement prong. In contrast, when generating the Integrated Media Index for a basic consumer product, the advertising prong is frequently weighted the same as the news prong since there is minimal risk in a consumer making a poor choice in selecting the product.

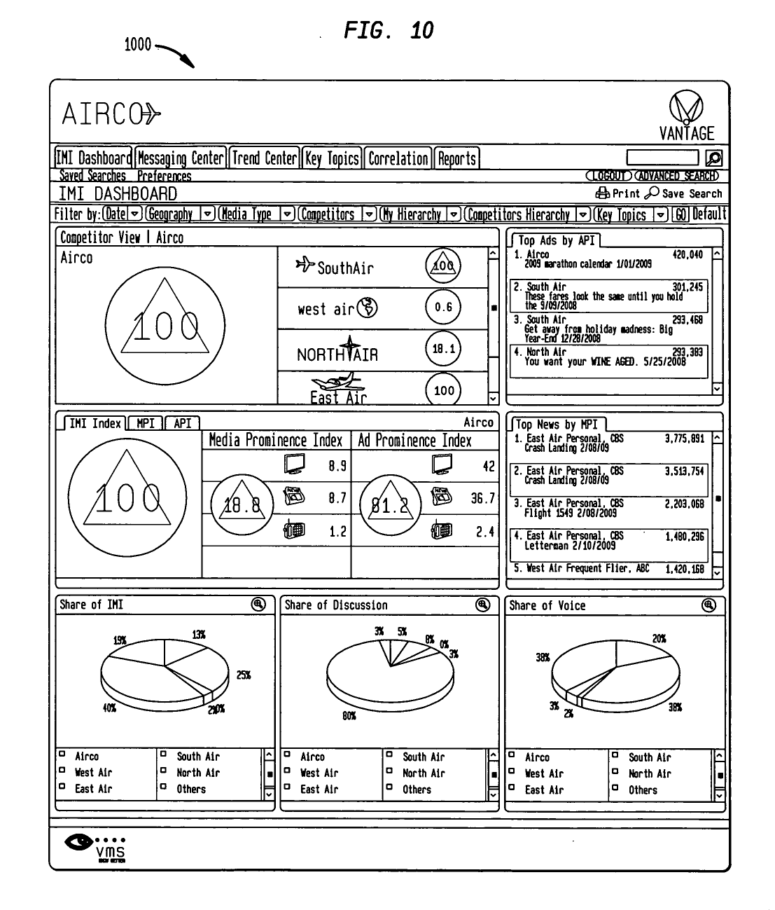

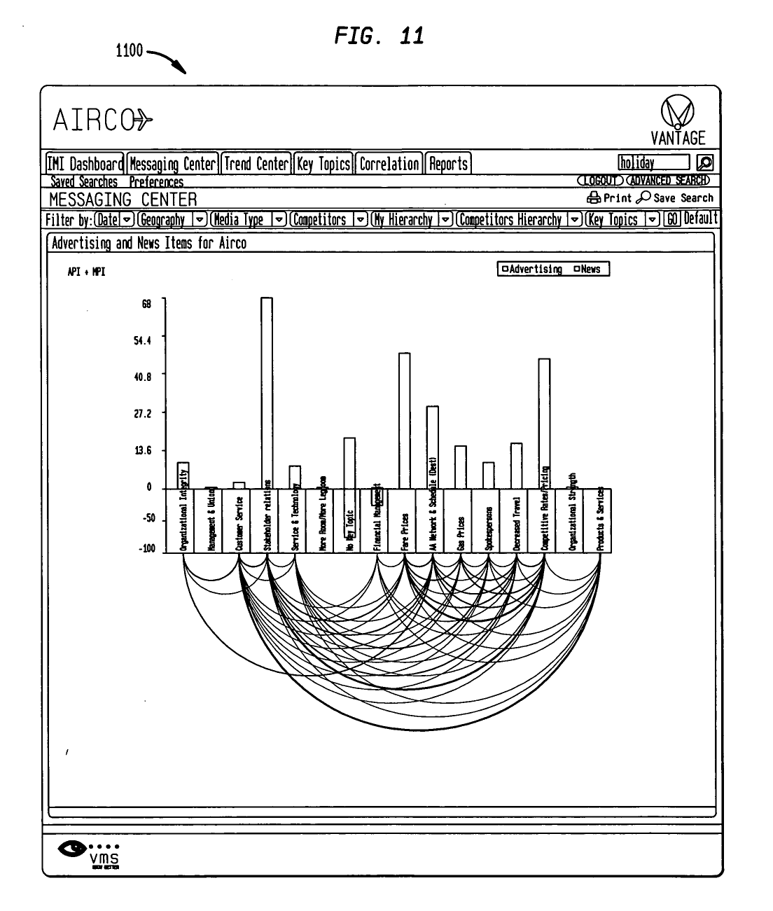

In order to generate the Integrated Media Index, news data is obtained in a real-time, ongoing basis. Upon receipt of the news data, the present invention, in accordance with particular parameters, gathers the appropriate news content and calculates an MPI value for each instance. Likewise, advertising information is obtained in a similar manner. As part of this capture, the spending level for each occurrence is established and maintained. As previously described herein, the Ad Effectiveness Index is calculated and dynamically modified in accordance with the principles of the present invention based on the current news environment. As a result, the present invention generates a calculated API value. For the time period of interest all the individual MPI values for each competitor and API values are combined and converted into an Integrated Media Index value for each competitor. In order to provide an effective correlation point, the Integrated Media Index value for the competitor with the highest Integrated Media Index value is indexed to 100 and all other competitors are scaled to that index. With the Integrated Media Index value of the target entity and the Integrated Media Index value of the industry competitors on-hand, various correlations can be generated, thereby providing an easy reference for correlating the impact of media and advertising. Examples of the various correlation functionality of the present invention is presented in further detail in FIG. 10 through FIG. 17.

For example, referring to FIG. 10, depicted is an example service display screen illustrating the Integrated Media Intelligence in accordance with an embodiment of the present invention. Specifically, Integrated Media Index dashboard 1000 in initial data view is proffered. In the present example, AIRCO exhibits a calculated Integrated Media Index of 100 as depicted in the large circle while competitor companies exhibit Integrated Media Index values ranging from 100 to 0.6. Further coding in colored form may be provided allowing for quick reference by a user. Additional references are also provided to indicate certain trends and attributes. For example, the triangle depicted within the Integrated Media Index circles reflect industry trend leaders (and in certain instances not depicted, negative references are indicted by a triangle pointed downward or neutral references may be exhibited as a right-pointed triangle). In addition, current MPI and API values for AIRCO are depicted as well as “Top Ads by API” and “Top News by MPI” of AIRCO and its relevant competitors.

Still referring to FIG. 10, various user filters are presented allowing a user to filter the data based on certain parameters. While various parameters may be incorporated, the parameters depicted in the present invention include setting the date range, prescribing the time period (e.g., today's activities, current week's (7 days) activities, current month's (30 days) activities, current quarter's (90 days) activities, current year's (365 days) activities, or any other custom date range), selecting a particular geography (e.g., regional, national, international, or the ability to define custom geographies or territories), selecting a plurality of media types (e.g., print, broadcast, internet, blogs, consumer generated media, etc.), establishing a hierarchy filter (i.e., enabling the inclusion or exclusion of an entire corporation, specific divisions, products within a division, models, etc.), establishing a competitor hierarchy (i.e., including or excluding specific competitors or models), and prescribing “Key” topics and messages.

Additional functionality can also be presented to the user such as the ability of the user to access breakout news coverage and advertising coverage by clicking various points within the screen such as by clicking the Integrated Media Index icon. In addition, in the present example, additional information can be displayed to the user such as the charts provided on the lower portion of Integrated Media Index dashboard 1000. In this particular example, pie charts are presented to provide a graphical view of Share of Discussion (News), Share of Voice (Advertising), and Integrated Share.

FIG. 11 illustrates example messaging module display screen 1100 depicting the levels of communications for each message or topic including the interrelation therebetween (i.e., the “co-occurrence”) in accordance with an embodiment of the present invention. Typically, messaging module display screen 1100 is presented in color allowing for quick reference by a user. In this example, the graphical bars, in two opposing colors, are designed to represent paid advertising as compared to news coverage. Arcs, depicted below graphical bars, exhibit the co-occurrence between topics with bolder arcs generally proportional to the level of co-occurrence. Further, color designations are designed to allow for overlap between events. Further designations can be made available allowing for the viewing of competitor activity transposed with the activity of AIRCO.

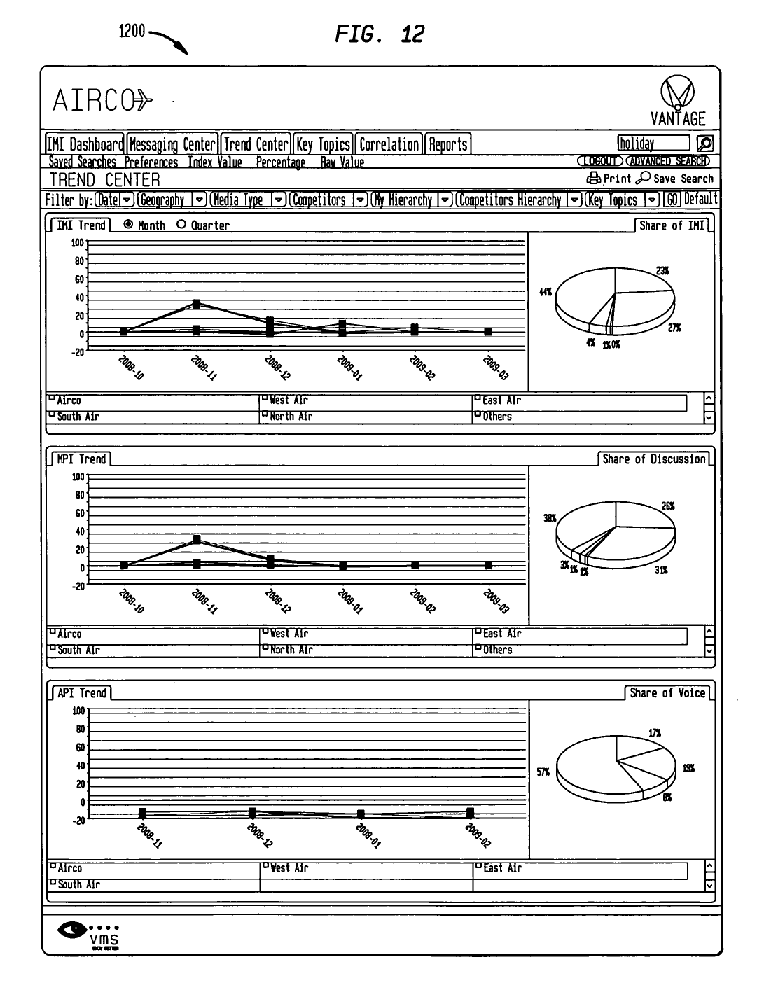

Turning next to FIG. 12, illustrated is example trend center display screen 1200 depicting the trends as a result of Index Values (i.e., Integrated Media Index, Media Prominence Index, and Advertising Prominence Index) for a specific time series in accordance with an embodiment of the present invention. For ease of reference and simplicity, a single data set is plotted in the present example, however, one of ordinary skill in the art will readily recognize that multiple data sets and data sets that have been mathematically manipulated in various ways can also be incorporated without departing from the spirit of the present invention. In the present example, all of the filters are active. Depending on the date range chosen, the X-axis of the data set will change and the precision choices will change. For example, this chart is depicted over several months with the X-axis chosen to be monthly, however, various alternate periods may be activated thereby altering the depiction of the data. Various additional charting functions may be employed such as the ability to chart the data as a function of Share (percentage) or raw data values.

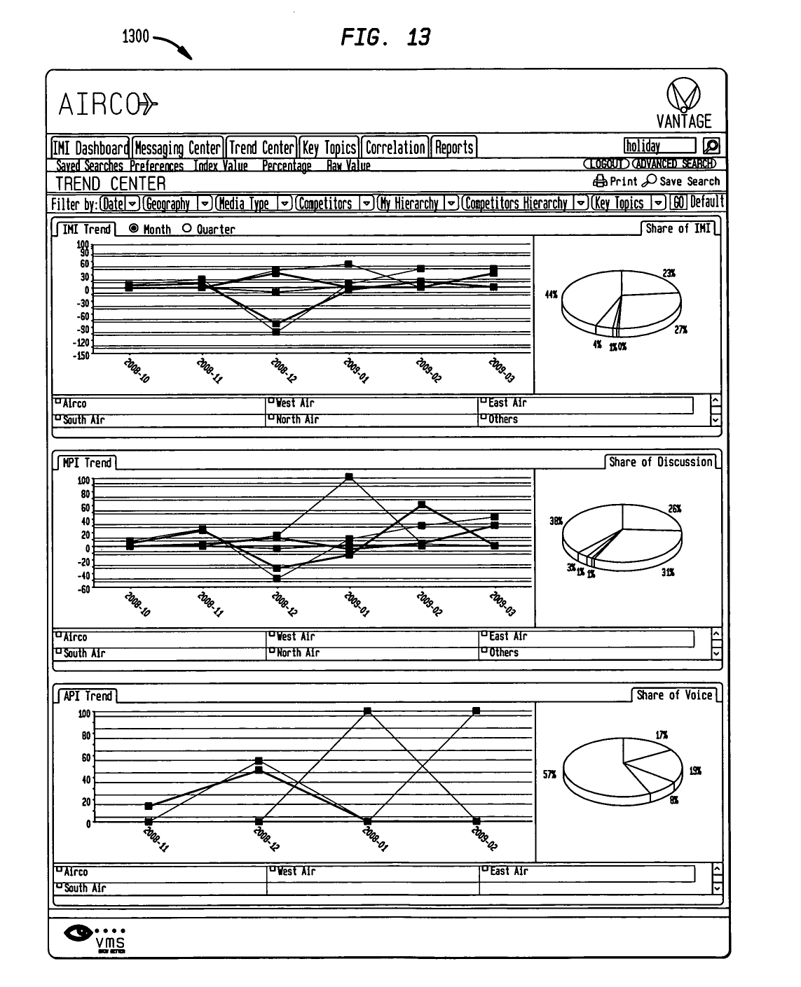

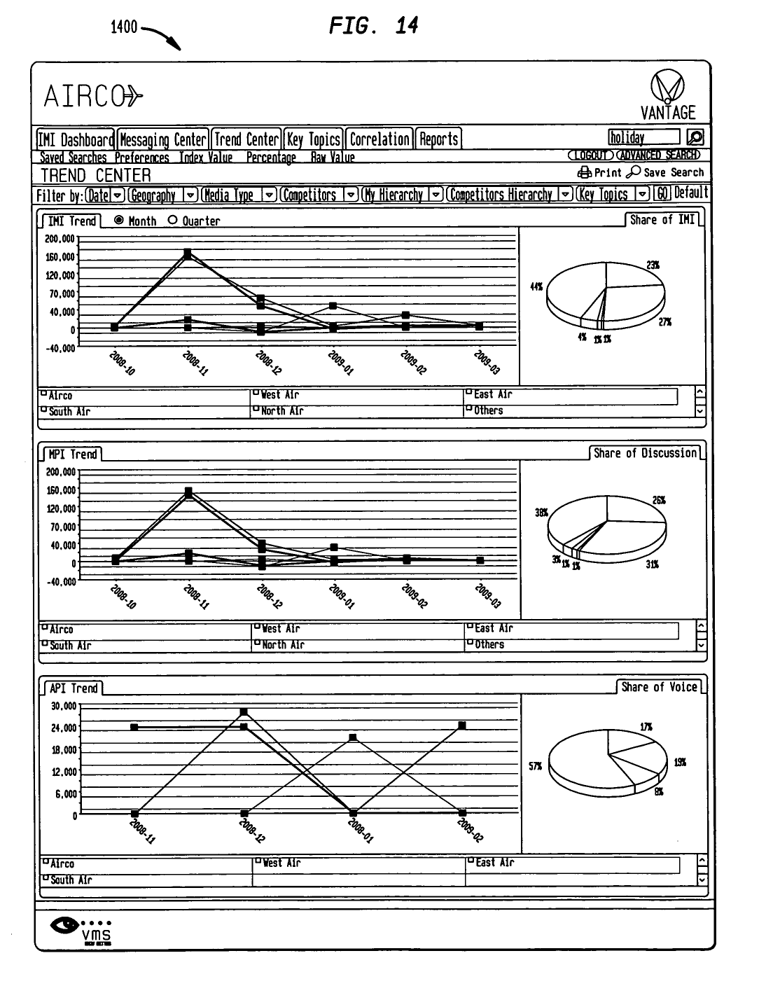

While example trend center display screen 1200 of FIG. 12 depicts trends as a function of Index Value, FIG. 13 illustrates example percentage trend center display screen 1300 depicting the trends as a result of the specific percentage of prominence indices in accordance with an embodiment of the present invention and FIG. 14 illustrates example raw value trend center display screen 1400 as a result of the specific raw value of prominence indices in accordance with an embodiment of the present invention.

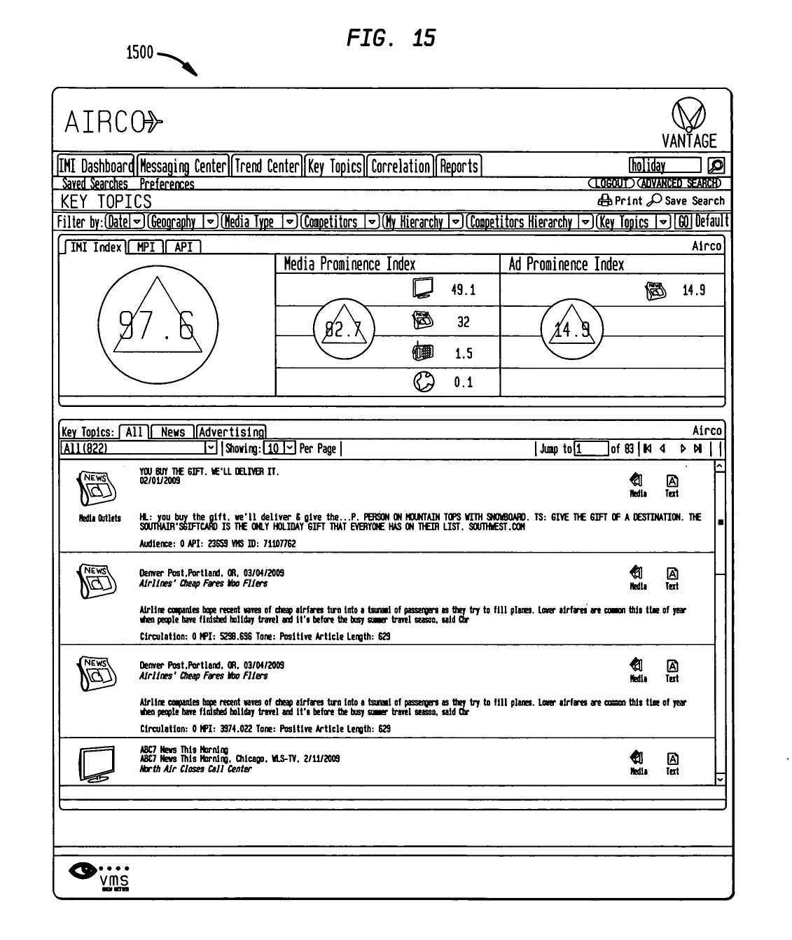

FIG. 15 illustrates example key topics display screen 1500 depicting data points reflecting actual individual news or advertising segments for generating correlation prominence metrics allowing a user to access and analyze individual data points in accordance with an embodiment of the present invention. Key topics display screen 1500 allows “drilldown” to the individual news or advertising segments that make up the data points. While various parameters can be assigned, in the present example, the data view can be chosen to show only news segments, only advertising, or all executions. The topic dropdown, “ALL (822)” can be selected enabling the user to view one or several topics and/or messages. Once selected, in the present example, a user can access the media icon or the text icon thereby accessing a full view of the data or in certain instances executing a download or buffer of a radio segment, television segment, scanned image of print, cached image of a web page, or other like media downloads. Further, a user can click on the various index identifiers presented (i.e., the 97.6 Integrated Media Index circle, the 82.7 Media Prominence Index circle, or the 14.9 Advertising Prominence Index) to access to specific data segments compiled to formulate the referenced indexes. Further exploration options can be available to a user such as advance drilldown options allowing for complete media information and additional aspects of particular media type components.

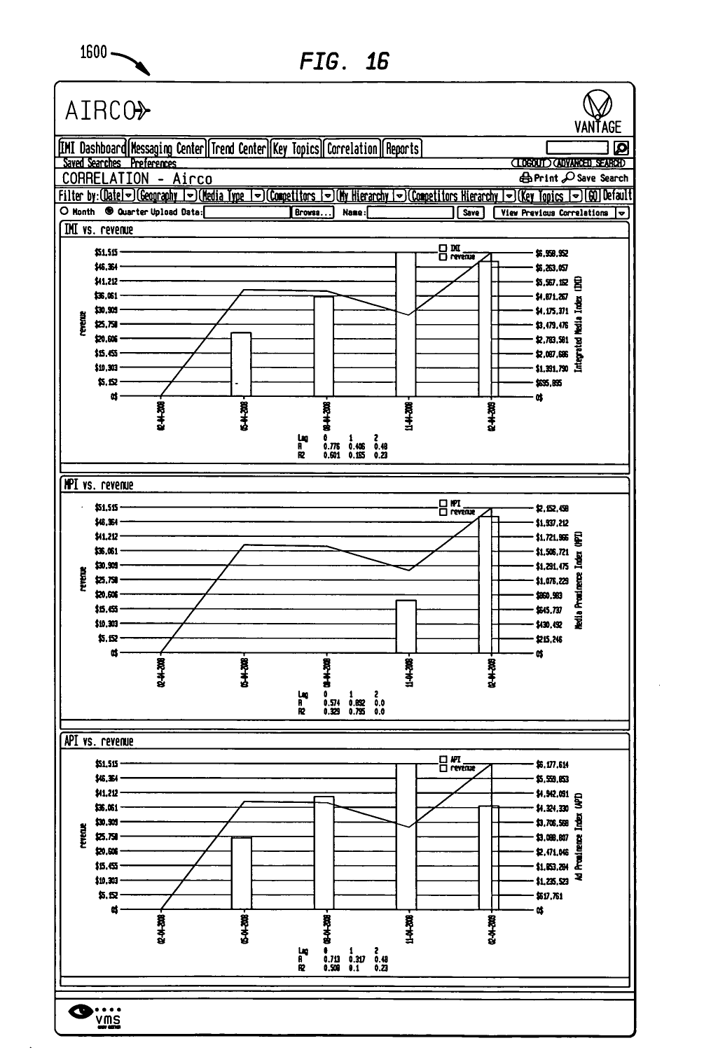

Turning next to FIG. 16, illustrated is example correlation module screen display 1600 for plotting various sets of variables obtained in the trend module or various sets of variables inputted from other sources in accordance with an embodiment of the present invention. The present examples provide three basic correlations (i.e., Integrated Media Index versus Revenue, Media Prominence Index versus Revenue, and Advertising Prominence Index versus Revenue) allowing further correlation as described in the present invention depicted in simple graphical form. Further statistical information is presented such a Pearson Correlation Coefficient “R” with no lag between the Integrated Media Index data and revenue, 1 period lag, and 2 period lags. It also shows the statistical “R²” metric. This example shows single variable, linear correlation, but one of ordinary skill in the art will readily recognize that far more complex correlation with multiple linear and non-linear variables can be accommodated.

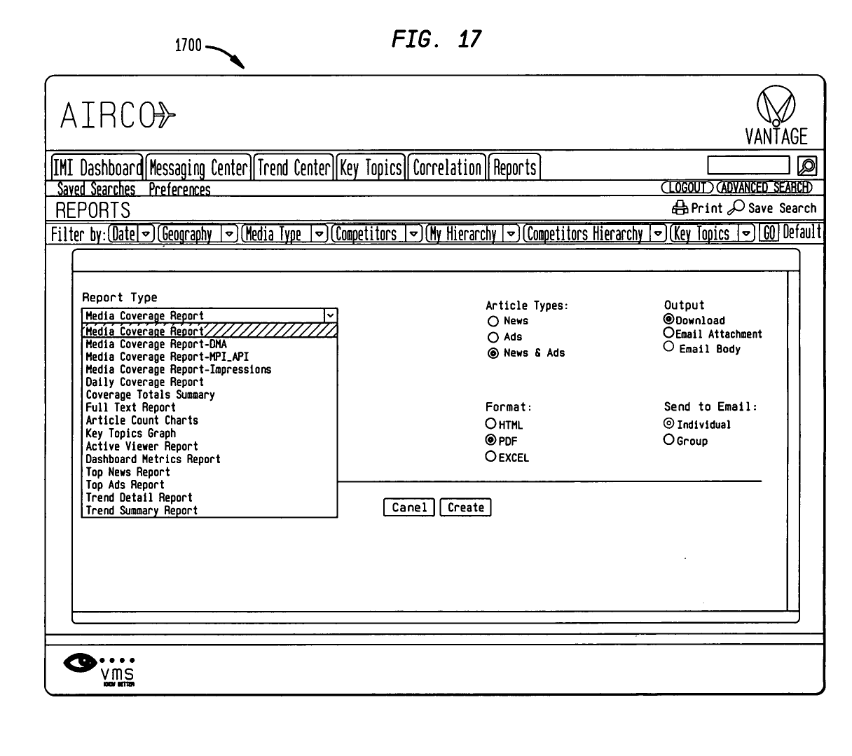

Next referring to FIG. 17, illustrated is example report module screen display 1700 allowing various reporting formats and delivery methods for same in accordance with an embodiment of the present invention. Various methods of transmission of reports and related functions are available in accordance with the principles of the present invention such as the transmission of reports in printed format, messaging format, various exporting options for integrations with other programs, systems, etc., various email transmissions, etc. Reports and datasets can also be included in RSS feeds and other automated reporting methodologies or transmission to cellular communication devices, or other portal electronic devices, as well as any similarly situated methods for transmitting data.

While the aforementioned figures related to the Integrated Media Index (primarily FIG. 10 through FIG. 17) merely depict the Integrated Media Index as a function of API and MPI (i.e., a function and independent variables attributable to advertising and news impact), the present invention is designed to allow for the introduction of additional data capable of impacting the metrics presented herein. For example, such additional data may be obtained through additional communications data streams, including but not limited to, data acquired through independent research, data acquired through independent data gathering activities, data obtained from third parties (either purchased or publicly distributed), data obtained from the client, etc. For example, such data may be acquired in the form of company directed emails or sales force communications. In addition, the additional data can include non-communications data, such as econometric data (e.g., published Gross Domestic Product information or the published unemployment rate for a specified time period). Further, additional data examples inputted can include stock price data, the results of brand tracking provided by an independent third party, or publicly available consumer purchase data. In addition, inputted data can include independent variable information, such as sales data, customer loyalty data, or product preference data. Of course, one of ordinary skill in the art will readily recognize that the examples provided herein are far from exhaustive as a plethora of relevant data may be incorporated into the analysis of the present invention while keeping with the spirit and intent of the present invention.

Similarly to the information obtained by the system of the present invention to generate the various metrics utilized and developed in the present invention, the additional data can be integrated with the present system and stored in an active database or can be accessed through appropriate permissions and protocols from a remote storage site. Likewise, the data can be accessed as a temporary data stream, immediately operated upon and evaluated. It is also contemplated by the present invention that the data can be stored for future use or verification and can be deleted once analyzed or discarded. Such storage parameters can be set based on data size, data relevancy, data classification (e.g., confidential, personal, sensitive, etc.), data importance, etc.

The additional data correlation module of the present invention is designed as an active system for expertly selecting appropriate independent variables and correlating the variables against outcome variables. The outcome variable can include sales data, public acceptance data, expense data, etc. It is further contemplated by the present invention that additional data correlation module can test the variables for independence, determine if the variable should be treated as linear or non-linear, and further correlate the variables based on certain parameters. In addition, delays between communications variables can be built into the system in particular desired scenarios. For example, in the pharmaceutical industry, communications typically lead prescription volume by thirteen weeks.

While it is a primary objective of the present invention to provide a series of correlation metrics for evaluating the impact of media, the impact of advertisement, and the collective effect of each value for evaluating past occurrences, one of ordinary skill in the art will readily recognize the future and planning value of the aforementioned metrics in modeling and predicting business outcomes. For example, the present invention enables correlation of communications activities to business outcomes which establishes a set of relationships. These relationships can be extended and enhanced to produce a model of communications and other drivers of business outcomes. Specifically, the relationships uncovered in the correlation analysis can be modeled and extended to be both predictive (i.e., project the current situation into the future based on a set of assumptions) and can also enable the assumptions to be changed and projected enabling a “what if” scenario development. This can be limited to the impact of communications on outcomes or other factors such as econometric variables, pricing, sales activities, product distribution, etc. Using probability analysis, a range of probable outcomes can be identified and scenarios that are optimal or that reduce risk to an acceptable level can be further selected.

From the foregoing description of the embodiments, which embodiments have been set forth in considerable detail for the purpose of making a complete disclosure of the present invention, it can be seen that the present invention comprises a system and method for managing, formatting, analyzing, transforming, correlating, and processing (including filtering, annotating and standardizing the content) media received from a plurality of media sources directly with advertising events as well as generating a series of metrics to enable a user to evaluate the impact of the media and advertising events.

It will be appreciated by those skilled in the art that changes could be made to the embodiment described above without departing from the broad inventive concept thereof. It is understood, therefore, that this invention is not limited to the particular embodiment disclosed, but it is intended to cover all modifications that are within the scope and spirit of the invention as defined by the appended claims.

1. A system for managing media received from a plurality of media sources, comprising:
a communication network for receiving media content from a media source, wherein the media content is formatted in a first format and comprises news material and advertising material, and further wherein the news material and the advertising material are related;
a processor coupled to said communication network for filtering, annotating and standardizing received media content, wherein the processor further transforms the media content from a first format to a second format; and
a memory coupled to said processor for storing the media content formatted in the second format, wherein the processor retrieves the processed content from the electronic storage repository in response to a search for the processed content, and transforms the processed content from the second format to a third format, and delivers the processed content in the third format to a user.

2. The system of claim 1, wherein the processor filters the media content by identifying content that is desired by a user according to defined rules.

3. The system of claim 1, wherein the second format is selected from a plurality of formats during the transformation of media content from the first format to the second format.

4. The system of claim 3, wherein the media content is received in printed format, video format or electronic format.

5. The system of claim 1, wherein the processor provides processed media content and graphical representations describing the processed media content to the user via the communication network.

6. The system of claim 1, wherein the processor calculates a media prominence index value in connection with the media content and uses the media prominence index value to determine a measure of impact the media content has on a viewer.

7. The system of claim 6, wherein the processor calculates advertising spending in connection with the media content and uses the media prominence index value and the advertising spending value to determine a measure of impact the media content has on a viewer.

8. The system of claim 1, wherein the processor categorizes the media content by subject matter.

9. The system of claim 1, wherein the processor receives user-defined custom report templates via the communication network and prepares reports that comply with the user-defined custom report templates.

10. The system of claim 1, wherein the subject relates to a brand, product, company, person, issue, message or personal preference.

11. The system of claim 1, wherein the processor includes security measures that preclude access to the content.

12. The system of claim 1, wherein the system further comprises folder management services that enable a user to organize data folders for storing the processed media content in the third format and further enables a user to access the data folders.

13. The system of claim 1, wherein the system comprises providing a showroom repository for users to create virtual showrooms for guests.

14. The system of claim 1, wherein the media content further comprises unpaid content and paid content.

15. The system of claim 14, wherein the system further comprises providing an integrated representation of the unpaid content and the paid content.

16. The system of claim 1, wherein the processor associates metadata with the media content.

17. The system of claim 16, wherein the metadata is generated as a function of analyzing the media content.

18. The system of claim 17, wherein the processor analyzes closed-caption text provided with media content formatted as video.

19. The system of claim 1, wherein the system further provides e-commerce services for users to purchase the processed content.

20. The system of claim 1, wherein the advertising material is paid for by a first party and the news material is not paid for by the first party.
